(19) United States
(12) Patent Application Publication
(10) Pub. No.: US 2025/0048291 A1
(43) Pub. Date: Feb. 6, 2025

(54) METHOD AND DEVICE FOR UPLINK TRANSMISSION/RECEPTION IN WIRELESS COMMUNICATION SYSTEM

(71) Applicant: LG Electronics Inc., Seoul (KR)

(72) Inventors: Seokmin SHIN, Seoul (KR); Haewook PARK, Seoul (KR); Kijun KIM, Seoul (KR); Joonkui AHN, Seoul (KR); Hyunsoo KO, Seoul (KR); Suckchel YANG, Seoul (KR); Seonwook KIM, Seoul (KR)

(21) Appl. No.: 18/261,224

(22) PCT Filed: Jan. 12, 2022
(86) PCT No.: PCT/KR2022/000531

§ 371 Date: Oct. 25, 2024

(30) Foreign Application Priority Data
Jan. 14, 2021 (KR) 10-2021-0005578
May 11, 2021 (KR) 10-2021-0060638
Aug. 5, 2021 (KR) 10-2021-0103408
Sep. 30, 2021 (KR) 10-2021-0130141

(51) Int. Cl. H04W 56/00; H04W 84/06

(52) U.S. Cl. CPC H04W 56/0045; H04W 56/0005; H04W 84/06

(57) ABSTRACT

A method and a device for uplink transmission/reception in a wireless communication system is disclosed. According to one embodiment of the present disclosure, a method by which a terminal performs uplink transmission in a wireless communication system may comprise the steps of: transmitting, to a base station, information related to a time reference adjustment value, on the basis of a predetermined threshold value for the time reference adjustment value; and performing uplink transmission on the basis of the information related to the time reference adjustment value.

### TECHNICAL FIELD

The present disclosure relates to a wireless communication system, and more specifically, relates to a method and a device of adjusting a reference for a time and/or a frequency applied to uplink transmission or reception in a wireless communication system.

### BACKGROUND ART

A mobile communication system has been developed to provide a voice service while guaranteeing mobility of users. However, a mobile communication system has extended even to a data service as well as a voice service, and currently, an explosive traffic increase has caused shortage of resources and users have demanded a faster service, so a more advanced mobile communication system has been required.

The requirements of a next-generation mobile communication system at large should be able to support accommodation of explosive data traffic, a remarkable increase in a transmission rate per user, accommodation of the significantly increased number of connected devices, very low End-to-End latency and high energy efficiency. To this end, a variety of technologies such as Dual Connectivity, Massive Multiple Input Multiple Output (Massive MIMO), In-band Full Duplex, Non-Orthogonal Multiple Access (NOMA), Super wideband Support, Device Networking, etc. have been researched.

### DISCLOSURE

### Technical Problem

A technical problem of the present disclosure is to provide a method and a device of transmitting or receiving an uplink in a wireless communication system.

An additional technical problem of the present disclosure is to provide a method and a device of adjusting or updating a reference for a time and/or a frequency applied to uplink transmission or reception in a wireless communication system including a non-terrestrial network (NTN).

The technical objects to be achieved by the present disclosure are not limited to the above-described technical objects, and other technical objects which are not described herein will be clearly understood by those skilled in the pertinent art from the following description.

### Technical Solution

A method of performing uplink transmission by a terminal in a wireless communication system according to an aspect of the present disclosure may include transmitting to a base station information related to a time reference adjustment value based on a predetermined threshold for a time reference adjustment value; and performing uplink transmission based on information related to the time reference adjustment value.

A method of receiving uplink transmission by a base station in a wireless communication system according to an additional aspect of the present disclosure may include receiving from a terminal information related to a time reference adjustment value based on a predetermined threshold for a time reference adjustment value; and receiving uplink transmission from the terminal based on information related to the time reference adjustment value.

### Technical Effects

According to the present disclosure, a method and a device of transmitting or receiving an uplink in a wireless communication system may be provided.

According to the present disclosure, a method and a device of adjusting or updating a reference for a time and/or a frequency applied to uplink transmission or reception in a wireless communication system including a non-terrestrial network (NTN) may be provided.

Effects achievable by the present disclosure are not limited to the above-described effects, and other effects which are not described herein may be clearly understood by those skilled in the pertinent art from the following description.

### DESCRIPTION OF DIAGRAMS

Accompanying drawings included as part of detailed description for understanding the present disclosure provide embodiments of the present disclosure and describe technical features of the present disclosure with detailed description.

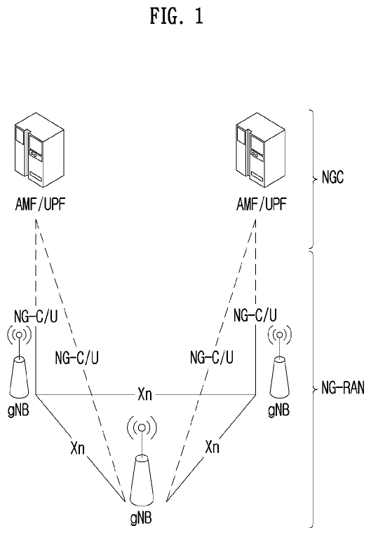

FIG. 1 illustrates a structure of a wireless communication system to which the present disclosure may be applied.

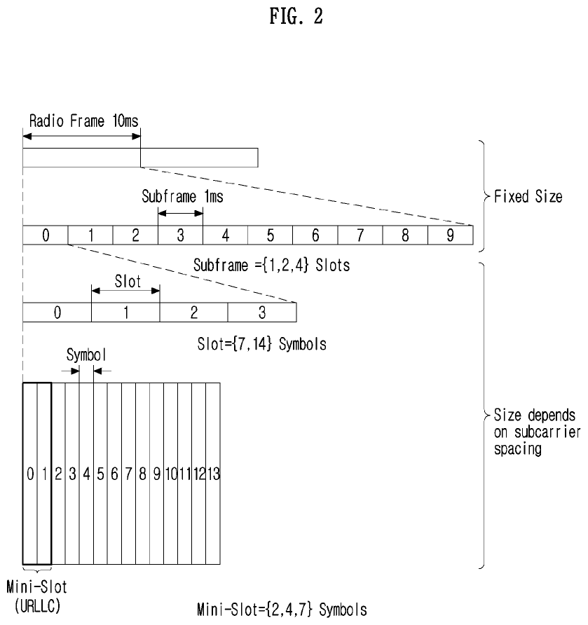

FIG. 2 illustrates a frame structure in a wireless communication system to which the present disclosure may be applied.

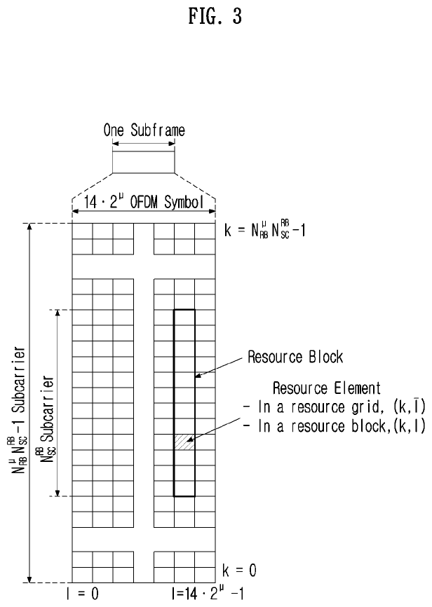

FIG. 3 illustrates a resource grid in a wireless communication system to which the present disclosure may be applied.

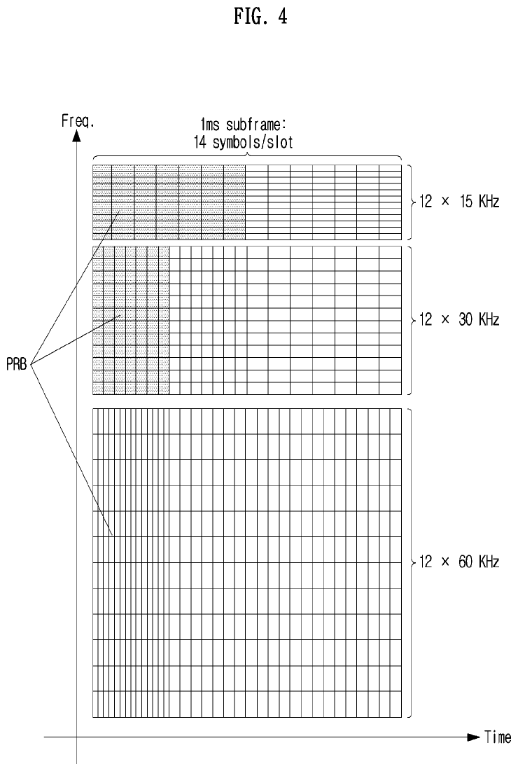

FIG. 4 illustrates a physical resource block in a wireless communication system to which the present disclosure may be applied.

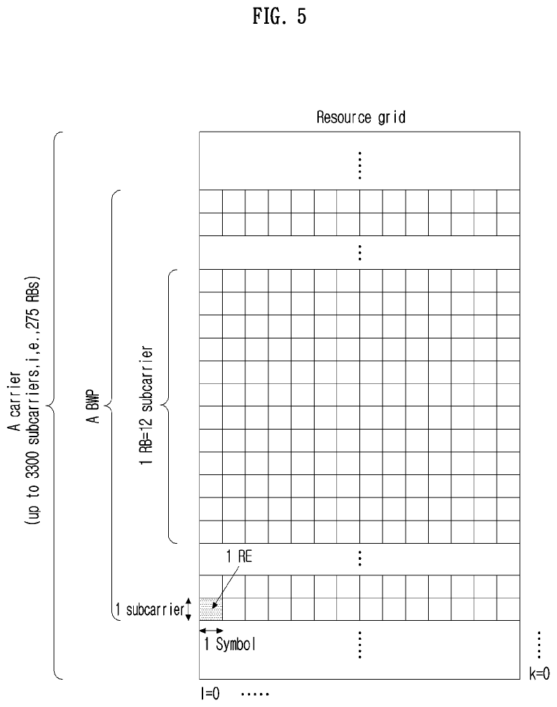

FIG. 5 illustrates a slot structure in a wireless communication system to which the present disclosure may be applied.

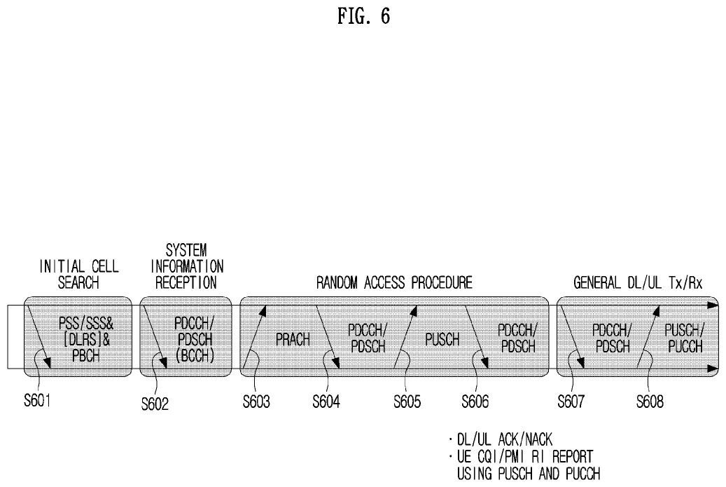

FIG. 6 illustrates physical channels used in a wireless communication system to which the present disclosure may be applied and a general signal transmission and reception method using them.

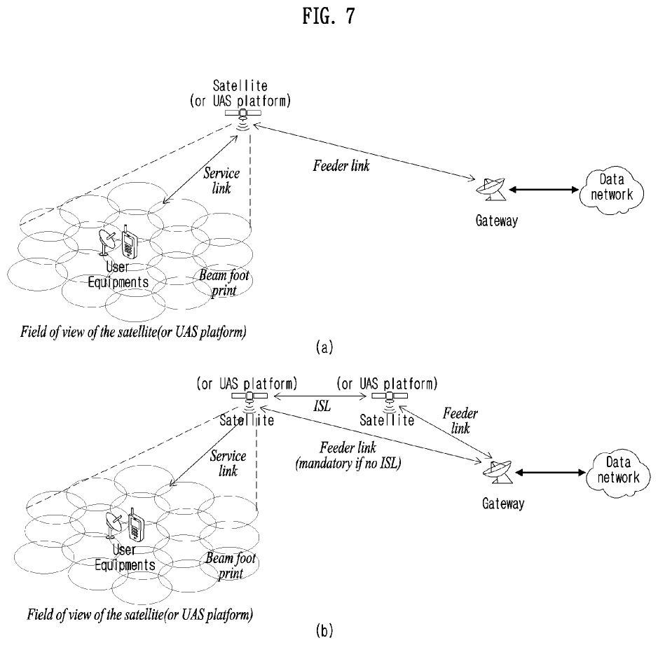

FIG. 7 is a diagram for describing a NTN supported by a wireless communication system to which the present disclosure may be applied.

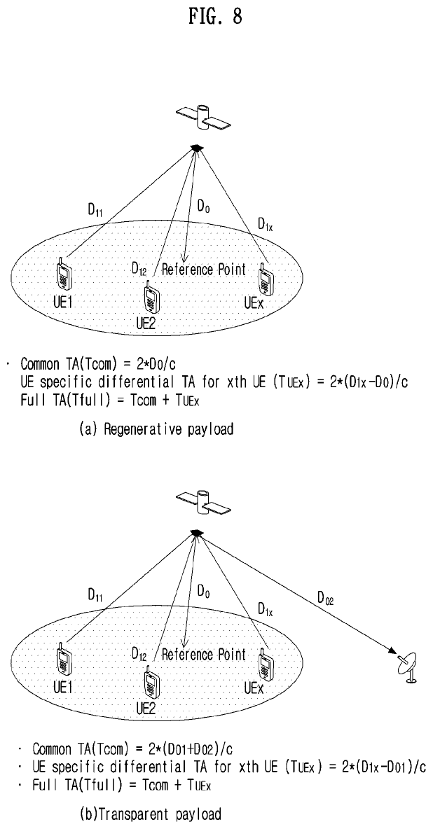

FIG. 8 is a diagram for describing a TA in a NTN supported by a wireless communication system to which the present disclosure may be applied.

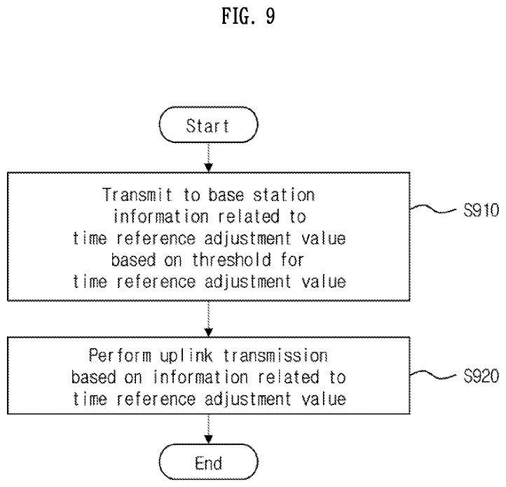

FIG. 9 is a flowchart for describing uplink transmission of a terminal according to an embodiment of the present disclosure.

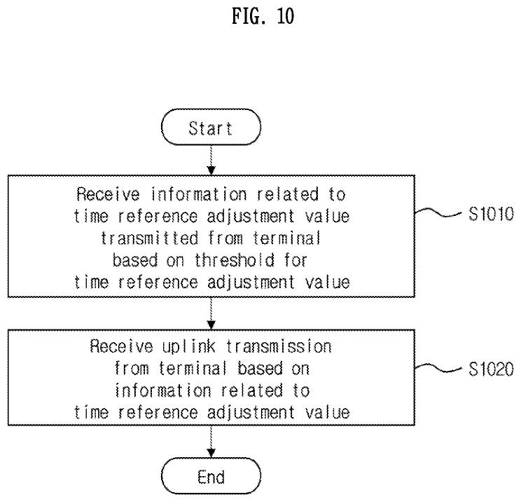

FIG. 10 is a flowchart for describing uplink reception of a base station according to an embodiment of the present disclosure.

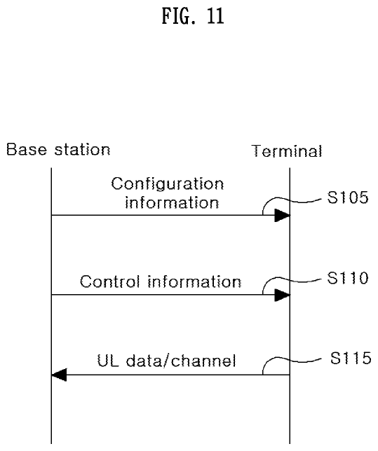

FIG. 11 is a diagram for illustrating a signaling process according to an embodiment of the present disclosure.

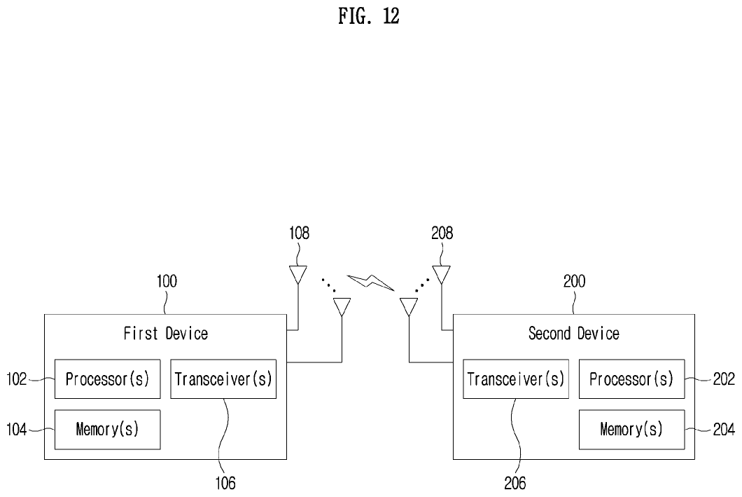

FIG. 12 is a diagram which illustrates a block diagram of a wireless communication device according to an embodiment of the present disclosure.

### BEST MODE

Hereinafter, embodiments according to the present disclosure will be described in detail by referring to accompanying drawings. Detailed description to be disclosed with accompanying drawings is to describe exemplary embodiments of the present disclosure and is not to represent the only embodiment that the present disclosure may be implemented. The following detailed description includes specific details to provide complete understanding of the present disclosure. However, those skilled in the pertinent art knows that the present disclosure may be implemented without such specific details.

In some cases, known structures and devices may be omitted or may be shown in a form of a block diagram based on a core function of each structure and device in order to prevent a concept of the present disclosure from being ambiguous.

In the present disclosure, when an element is referred to as being “connected”, “combined” or “linked” to another element, it may include an indirect connection relation that yet another element presents therebetween as well as a direct connection relation. In addition, in the present disclosure, a term, “include” or “have”, specifies the presence of a mentioned feature, step, operation, component and/or element, but it does not exclude the presence or addition of one or more other features, stages, operations, components, elements and/or their groups.

In the present disclosure, a term such as “first”, “second”, etc. is used only to distinguish one element from other element and is not used to limit elements, and unless otherwise specified, it does not limit an order or importance, etc. between elements. Accordingly, within a scope of the present disclosure, a first element in an embodiment may be referred to as a second element in another embodiment and likewise, a second element in an embodiment may be referred to as a first element in another embodiment.

A term used in the present disclosure is to describe a specific embodiment, and is not to limit a claim. As used in a described and attached claim of an embodiment, a singular form is intended to include a plural form, unless the context clearly indicates otherwise. A term used in the present disclosure, “and/or”, may refer to one of related enumerated items or it means that it refers to and includes any and all possible combinations of two or more of them. In addition, “/” between words in the present disclosure has the same meaning as “and/or”, unless otherwise described.

The present disclosure describes a wireless communication network or a wireless communication system, and an operation performed in a wireless communication network may be performed in a process in which a device (e.g., a base station) controlling a corresponding wireless communication network controls a network and transmits or receives a signal, or may be performed in a process in which a terminal associated to a corresponding wireless network transmits or receives a signal with a network or between terminals.

In the present disclosure, transmitting or receiving a channel includes a meaning of transmitting or receiving information or a signal through a corresponding channel. For example, transmitting a control channel means that control information or a control signal is transmitted through a control channel. Similarly, transmitting a data channel means that data information or a data signal is transmitted through a data channel.

Hereinafter, a downlink (DL) means a communication from a base station to a terminal and an uplink (UL) means a communication from a terminal to a base station. In a downlink, a transmitter may be part of a base station and a receiver may be part of a terminal. In an uplink, a transmitter may be part of a terminal and a receiver may be part of a base station. A base station may be expressed as a first communication device and a terminal may be expressed as a second communication device. A base station (BS) may be substituted with a term such as a fixed station, a Node B, an eNB (evolved-NodeB), a gNB (Next Generation NodeB), a BTS (base transceiver system), an Access Point (AP), a Network (5G network), an AI (Artificial Intelligence) system/module, an RSU (road side unit), a robot, a drone (UAV: Unmanned Aerial Vehicle), an AR (Augmented Reality) device, a VR (Virtual Reality) device, etc. In addition, a terminal may be fixed or mobile, and may be substituted with a term such as a UE (User Equipment), an MS (Mobile Station), a UT (user terminal), an MSS (Mobile Subscriber Station), an SS (Subscriber Station), an AMS (Advanced Mobile Station), a WT (Wireless terminal), an MTC (Machine-Type Communication) device, an M2M (Machine-to-Machine) device, a D2D (Device-to-Device) device, a vehicle, an RSU (road side unit), a robot, an AI (Artificial Intelligence) module, a drone (UAV: Unmanned Aerial Vehicle), an AR (Augmented Reality) device, a VR (Virtual Reality) device, etc.

The following description may be used for a variety of radio access systems such as CDMA, FDMA, TDMA, OFDMA, SC-FDMA, etc. CDMA may be implemented by a wireless technology such as UTRA (Universal Terrestrial Radio Access) or CDMA2000. TDMA may be implemented by a radio technology such as GSM (Global System for Mobile communications)/GPRS (General Packet Radio Service)/EDGE (Enhanced Data Rates for GSM Evolution). OFDMA may be implemented by a radio technology such as IEEE 802.11 (Wi-Fi), IEEE 802.16 (WiMAX), IEEE 802-20, E-UTRA (Evolved UTRA), etc. UTRA is a part of a UMTS (Universal Mobile Telecommunications System). 3GPP (3rd Generation Partnership Project) LTE (Long Term Evolution) is a part of an E-UMTS (Evolved UMTS) using E-UTRA and LTE-A (Advanced)/LTE-A pro is an advanced version of 3GPP LTE. 3GPP NR (New Radio or New Radio Access Technology) is an advanced version of 3GPP LTE/LTE-A/LTE-A pro.

To clarify description, it is described based on a 3GPP communication system (e.g., LTE-A, NR), but a technical idea of the present disclosure is not limited thereto. LTE means a technology after 3GPP TS (Technical Specification) 36.xxx Release 8. In detail, an LTE technology in or after 3GPP TS 36.xxx Release 10 is referred to as LTE-A and an LTE technology in or after 3GPP TS 36.xxx Release 13 is referred to as LTE-A pro. 3GPP NR means a technology in or after TS 38.xxx Release 15. LTE/NR may be referred to as a 3GPP system. “xxx” means a detailed number for a standard document. LTE/NR may be commonly referred to as a 3GPP system. For a background art, a term, an abbreviation, etc. used to describe the present disclosure, matters described in a standard document disclosed before the present disclosure may be referred to. For example, the following document may be referred to.

For 3GPP LTE, TS 36.211 (physical channels and modulation), TS 36.212 (multiplexing and channel coding), TS 36.213 (physical layer procedures), TS 36.300 (overall description), TS 36.331 (radio resource control) may be referred to.

For 3GPP NR, TS 38.211 (physical channels and modulation), TS 38.212 (multiplexing and channel coding), TS 38.213 (physical layer procedures for control), TS 38.214 (physical layer procedures for data), TS 38.300 (NR and NG-RAN (New Generation-Radio Access Network) overall description), TS 38.331 (radio resource control protocol specification) may be referred to.

Abbreviations of terms which may be used in the present disclosure is defined as follows.
BM: beam management
CQI: Channel Quality Indicator
CRI: channel state information-reference signal resource indicator
CSI: channel state information
CSI-IM: channel state information-interference measurement
CSI-RS: channel state information-reference signal
DMRS: demodulation reference signal
FDM: frequency division multiplexing
FFT: fast Fourier transform
IFDMA: interleaved frequency division multiple access
IFFT: inverse fast Fourier transform
L1-RSRP: Layer 1 reference signal received power
L1-RSRQ: Layer 1 reference signal received quality
MAC: medium access control
NZP: non-zero power
OFDM: orthogonal frequency division multiplexing
PDCCH: physical downlink control channel
PDSCH: physical downlink shared channel
PMI: precoding matrix indicator
RE: resource element
RI: Rank indicator
RRC: radio resource control
RSSI: received signal strength indicator
Rx: Reception
QCL: quasi co-location
SINR: signal to interference and noise ratio
SSB (or SS/PBCH block): Synchronization signal block (including PSS (primary synchronization signal), SSS (secondary synchronization signal) and PBCH (physical broadcast channel))
TDM: time division multiplexing
TRP: transmission and reception point
TRS: tracking reference signal
Tx: transmission
UE: user equipment
ZP: zero power

### Overall System

As more communication devices have required a higher capacity, a need for an improved mobile broadband communication compared to the existing radio access technology (RAT) has emerged. In addition, massive MTC (Machine Type Communications) providing a variety of services anytime and anywhere by connecting a plurality of devices and things is also one of main issues which will be considered in a next-generation communication. Furthermore, a communication system design considering a service/a terminal sensitive to reliability and latency is also discussed. As such, introduction of a next-generation RAT considering eMBB (enhanced mobile broadband communication), mMTC (massive MTC), URLLC (Ultra-Reliable and Low Latency Communication), etc. is discussed and, for convenience, a corresponding technology is referred to as NR in the present disclosure. NR is an expression which represents an example of a 5G RAT.

A new RAT system including NR uses an OFDM transmission method or a transmission method similar to it. A new RAT system may follow OFDM parameters different from OFDM parameters of LTE. Alternatively, a new RAT system follows a numerology of the existing LTE/LTE-A as it is, but may support a wider system bandwidth (e.g., 100 MHz). Alternatively, one cell may support a plurality of numerologies. In other words, terminals which operate in accordance with different numerologies may coexist in one cell.

A numerology corresponds to one subcarrier spacing in a frequency domain. As a reference subcarrier spacing is scaled by an integer N, a different numerology may be defined.

FIG. 1 illustrates a structure of a wireless communication system to which the present disclosure may be applied.

In reference to FIG. 1, NG-RAN is configured with gNBs which provide a control plane (RRC) protocol end for a NG-RA (NG-Radio Access) user plane (i.e., a new AS (access stratum) sublayer/PDCP (Packet Data Convergence Protocol)/RLC (Radio Link Control)/MAC/PHY) and UE. The gNBs are interconnected through a Xn interface. The gNB, in addition, is connected to an NGC (New Generation Core) through an NG interface. In more detail, the gNB is connected to an AMF (Access and Mobility Management Function) through an N2 interface, and is connected to a UPF (User Plane Function) through an N3 interface.

FIG. 2 illustrates a frame structure in a wireless communication system to which the present disclosure may be applied.

A NR system may support a plurality of numerologies. Here, a numerology may be defined by a subcarrier spacing and a cyclic prefix (CP) overhead. Here, a plurality of subcarrier spacings may be derived by scaling a basic (reference) subcarrier spacing by an integer N (or, u). In addition, although it is assumed that a very low subcarrier spacing is not used in a very high carrier frequency, a used numerology may be selected independently from a frequency band. In addition, a variety of frame structures according to a plurality of numerologies may be supported in a NR system.

Hereinafter, an OFDM numerology and frame structure which may be considered in a NR system will be described. A plurality of OFDM numerologies supported in a NR system may be defined as in the following Table 1.

TABLE 1

| μ | Δf = 2^{μ} · 15 [kHz] | CP |
|---|---|---|
| 0 | 15 | Normal |
| 1 | 30 | Normal |
| 2 | 60 | Normal, Extended |
| 3 | 120 | Normal |
| 4 | 240 | Normal |

NR supports a plurality of numerologies (or subcarrier spacings (SCS)) for supporting a variety of 5G services. For example, when a SCS is 15 kHz, a wide area in traditional cellular bands is supported, and when a SCS is 30 kHz/60 kHz, dense-urban, lower latency and a wider carrier bandwidth are supported, and when a SCS is 60 kHz or higher, a bandwidth wider than 24.25 GHz is supported to overcome a phase noise. An NR frequency band is defined as a frequency range in two types (FR1, FR2). FR1, FR2 may be configured as in the following Table 2. In addition, FR2 may mean a millimeter wave (mmW).

TABLE 2

| Frequency Range | Corresponding | Subcarrier |
|---|---|---|
| designation | frequency range | Spacing |
| FR1 | 410 MHz-7125 MHz | 15, 30, 60 kHz |
| FR2 | 24250 MHz-52600 MHz | 60, 120, 240 kHz |

Regarding a frame structure in an NR system, a size of a variety of fields in a time domain is expresses as a multiple of a time unit of T_{c}=1/(Δfₘₐₓ·N_{f}). Here, Δfₘₐₓ is 480·10³ Hz and N_{f} is 4096. Downlink and uplink transmission is configured (organized) with a radio frame having a duration of T_{f}=1/(ΔfₘₐₓN_{f}/100). T_{c}=10 ms. Here, a radio frame is configured with 10 subframes having a duration of T_{sf}=(ΔfₘₐₓN_{f}/1000)·T_{c}=1 ms, respectively. In this case, there may be one set of frames for an uplink and one set of frames for a downlink. In addition, transmission in an uplink frame No. i from a terminal should start earlier by T_{TA}=(N_{TA}+N_{TA,offset})T_{c} than a corresponding downlink frame in a corresponding terminal starts. For a subcarrier spacing configuration u, slots are numbered in an increasing order of nₛμ∈{0, . . . , Nₛₗₒₜ^{subframe,μ}−1} in a subframe and are numbered in an increasing order of n_{s,f}^{μ}∈{0, . . . , Nₛₗₒₜ^{frame,μ}−1} in a radio frame. One slot is configured with N_{symb}^{slot} consecutive OFDM symbols and N_{symb}^{slot} is determined according to CP. A start of a slot nₛ^{μ} in a subframe is temporally arranged with a start of an OFDM symbol nₛ^{μ}N_{symb}^{slot} in the same subframe. All terminals may not perform transmission and reception at the same time, which means that all OFDM symbols of a downlink slot or an uplink slot may not be used. Table 3 represents the number of OFDM symbols per slot (N_{symb}^{slot}), the number of slots per radio frame (Nₛₗₒₜ^{frame,μ}) and the number of slots per subframe (Nₛₗₒₜ^{subframe,μ}) in a normal CP and Table 4 represents the number of OFDM symbols per slot, the number of slots per radio frame and the number of slots per subframe in an extended CP.

TABLE 3

| μ | N_{symb}^{slot} | Nₛₗₒₜ^{frame,μ} | Nₛₗₒₜ^{subframe,μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

TABLE 4

| μ | N_{symb}^{slot} | Nₛₗₒₜ^{frame,μ} | Nₛₗₒₜ^{subframe,μ} |
|---|---|---|---|
| 2 | 12 | 40 | 4 |

FIG. 2 is an example on μ=2 (SCS is 60 kHz), 1 subframe may include 4 slots referring to Table 3. 1 subframe={1,2,4} slot shown in FIG. 2 is an example, the number of slots which may be included in 1 subframe is defined as in Table 3 or Table 4. In addition, a mini-slot may include 2, 4 or 7 symbols or more or less symbols. Regarding a physical resource in a NR system, an antenna port, a resource grid, a resource element, a resource block, a carrier part, etc. may be considered. Hereinafter, the physical resources which may be considered in an NR system will be described in detail. First, in relation to an antenna port, an antenna port is defined so that a channel where a symbol in an antenna port is carried can be inferred from a channel where other symbol in the same antenna port is carried. When a large-scale property of a channel where a symbol in one antenna port is carried may be inferred from a channel where a symbol in other antenna port is carried, it may be said that 2 antenna ports are in a QC/QCL (quasi co-located or quasi co-location) relationship. In this case, the large-scale property includes at least one of delay spread, doppler spread, frequency shift, average received power, received timing. FIG. 3 illustrates a resource grid in a wireless communication system to which the present disclosure may be applied. In reference to FIG. 3, it is illustratively described that a resource grid is configured with N_{RB}^{μ}N_{sc}^{RB} subcarriers in a frequency domain and one subframe is configured with 14·2^{μ} OFDM symbols, but it is not limited thereto. In an NR system, a transmitted signal is described by OFDM symbols of 2^{μ}N_{symb}^{(μ)} and one or more resource grids configured with N_{RB}^{μ}N_{sc}^{RB} subcarriers. Here, N_{RB}^{μ}≤N_{RB}^{max,μ}. The N_{RB}^{max,μ} represents a maximum transmission bandwidth, which may be different between an uplink and a downlink as well as between numerologies. In this case, one resource grid may be configured per μ and antenna port p. Each element of a resource grid for μ and an antenna port p is referred to as a resource element and is uniquely identified by an index pair (k,l′). Here, k=0, . . . , N_{RB}^{μ}N_{sc}^{RB}−1 is an index in a frequency domain and l′=0, . . . , 2^{μ}N_{symb}^{(μ)}−1 refers to a position of a symbol in a subframe. When referring to a resource element in a slot, an index pair (k,l) is used. Here, l=0, . . . , N_{symb}^{μ}−1. A resource element (k,l′) for μ and an antenna port p corresponds to a complex value, a_{k,l′}^{(p,μ)}. When there is no risk of confusion or when a specific antenna port or numerology is not specified, indexes p and μ may be dropped, whereupon a complex value may be a_{k,l′}^{(p)} or a_{k,l′}. In addition, a resource block (RB) is defined as N_{sc}^{RB}=12 consecutive subcarriers in a frequency domain.

Point A plays a role as a common reference point of a resource block grid and is obtained as follows.

offsetToPointA for a primary cell (PCell) downlink represents a frequency offset between point A and the lowest subcarrier of the lowest resource block overlapped with a SS/PBCH block which is used by a terminal for an initial cell selection. It is expressed in resource block units assuming a 15 kHz subcarrier spacing for FR1 and a 60 kHz subcarrier spacing for FR2.

absoluteFrequencyPointA represents a frequency-position of point A expressed as in ARFCN (absolute radio-frequency channel number).

Common resource blocks are numbered from 0 to the top in a frequency domain for a subcarrier spacing configuration μ. The center of subcarrier 0 of common resource block 0 for a subcarrier spacing configuration μ is identical to ‘point A’. A relationship between a common resource block number n_{CRB}^{μ} and a resource element (k,l) for a subcarrier spacing configuration μ in a frequency domain is given as in the following Equation 1.

$${n}_{CRB}^{μ} = ⌊ \frac{k}{{N}_{sc}^{RB}} ⌋ \qquad [ Equation 1 ]$$

In Equation 1, k is defined relatively to point A so that k=0 corresponds to a subcarrier centering in point A. Physical resource blocks are numbered from 0 to N_{BWP,i}^{size,μ}−1 in a bandwidth part (BWP) and i is a number of a BWP. A relationship between a physical resource block n_{PRB} and a common resource block n_{CRB} in BWP i is given by the following Equation 2.

$${n}_{CRB}^{μ} = {n}_{PRB}^{μ} + {N}_{BWP , i}^{start , μ} \qquad [ Equation 2 ]$$

N_{BWP,i}^{start,μ} is a common resource block that a BWP starts relatively to common resource block 0.

FIG. 4 illustrates a physical resource block in a wireless communication system to which the present disclosure may be applied. And, FIG. 5 illustrates a slot structure in a wireless communication system to which the present disclosure may be applied.

In reference to FIG. 4 and FIG. 5, a slot includes a plurality of symbols in a time domain. For example, for a normal CP, one slot includes 7 symbols, but for an extended CP, one slot includes 6 symbols.

A carrier includes a plurality of subcarriers in a frequency domain. An RB (Resource Block) is defined as a plurality of (e.g., 12) consecutive subcarriers in a frequency domain. A BWP (Bandwidth Part) is defined as a plurality of consecutive (physical) resource blocks in a frequency domain and may correspond to one numerology (e.g., an SCS, a CP length, etc.). A carrier may include a maximum N (e.g., 5) BWPs. A data communication may be performed through an activated BWP and only one BWP may be activated for one terminal. In a resource grid, each element is referred to as a resource element (RE) and one complex symbol may be mapped.

In an NR system, up to 400 MHz may be supported per component carrier (CC). If a terminal operating in such a wideband CC always operates turning on a radio frequency (FR) chip for the whole CC, terminal battery consumption may increase. Alternatively, when several application cases operating in one wideband CC (e.g., eMBB, URLLC, Mmtc, V2X, etc.) are considered, a different numerology (e.g., a subcarrier spacing, etc.) may be supported per frequency band in a corresponding CC. Alternatively, each terminal may have a different capability for the maximum bandwidth. By considering it, a base station may indicate a terminal to operate only in a partial bandwidth, not in a full bandwidth of a wideband CC, and a corresponding partial bandwidth is defined as a bandwidth part (BWP) for convenience. A BWP may be configured with consecutive RBs on a frequency axis and may correspond to one numerology (e.g., a subcarrier spacing, a CP length, a slot/a mini-slot duration).

Meanwhile, a base station may configure a plurality of BWPs even in one CC configured to a terminal. For example, a BWP occupying a relatively small frequency domain may be configured in a PDCCH monitoring slot, and a PDSCH indicated by a PDCCH may be scheduled in a greater BWP. Alternatively, when UEs are congested in a specific BWP, some terminals may be configured with other BWP for load balancing. Alternatively, considering frequency domain inter-cell interference cancellation between neighboring cells, etc., some middle spectrums of a full bandwidth may be excluded and BWPs on both edges may be configured in the same slot. In other words, a base station may configure at least one DL/UL BWP to a terminal associated with a wideband CC. A base station may activate at least one DL/UL BWP of configured DL/UL BWP(s) at a specific time (by L1 signaling or MAC CE (Control Element) or RRC signaling, etc.). In addition, a base station may indicate switching to other configured DL/UL BWP (by L1 signaling or MAC CE or RRC signaling, etc.). Alternatively, based on a timer, when a timer value is expired, it may be switched to a determined DL/UL BWP. Here, an activated DL/UL BWP is defined as an active DL/UL BWP. But, a configuration on a DL/UL BWP may not be received when a terminal performs an initial access procedure or before a RRC connection is set up, so a DL/UL BWP which is assumed by a terminal under these situations is defined as an initial active DL/UL BWP.

FIG. 6 illustrates physical channels used in a wireless communication system to which the present disclosure may be applied and a general signal transmission and reception method using them.

In a wireless communication system, a terminal receives information through a downlink from a base station and transmits information through an uplink to a base station. Information transmitted and received by a base station and a terminal includes data and a variety of control information and a variety of physical channels exist according to a type/a usage of information transmitted and received by them.

When a terminal is turned on or newly enters a cell, it performs an initial cell search including synchronization with a base station or the like (S601). For the initial cell search, a terminal may synchronize with a base station by receiving a primary synchronization signal (PSS) and a secondary synchronization signal (SSS) from a base station and obtain information such as a cell identifier (ID), etc. After that, a terminal may obtain broadcasting information in a cell by receiving a physical broadcast channel (PBCH) from a base station. Meanwhile, a terminal may check out a downlink channel state by receiving a downlink reference signal (DL RS) at an initial cell search stage.

A terminal which completed an initial cell search may obtain more detailed system information by receiving a physical downlink control channel (PDCCH) and a physical downlink shared channel (PDSCH) according to information carried in the PDCCH (S602).

Meanwhile, when a terminal accesses to a base station for the first time or does not have a radio resource for signal transmission, it may perform a random access (RACH) procedure to a base station (S603 to S606). For the random access procedure, a terminal may transmit a specific sequence as a preamble through a physical random access channel (PRACH) (S603 and S605) and may receive a response message for a preamble through a PDCCH and a corresponding PDSCH (S604 and S606). A contention based RACH may additionally perform a contention resolution procedure.

A terminal which performed the above-described procedure subsequently may perform PDCCH/PDSCH reception (S607) and PUSCH (Physical Uplink Shared Channel)/PUCCH (physical uplink control channel) transmission (S608) as a general uplink/downlink signal transmission procedure. In particular, a terminal receives downlink control information (DCI) through a PDCCH. Here, DCI includes control information such as resource allocation information for a terminal and a format varies depending on its purpose of use.

Meanwhile, control information which is transmitted by a terminal to a base station through an uplink or is received by a terminal from a base station includes a downlink/uplink ACK/NACK (Acknowledgement/Non-Acknowledgement) signal, a CQI (Channel Quality Indicator), a PMI (Precoding Matrix Indicator), a RI (Rank Indicator), etc. For a 3GPP LTE system, a terminal may transmit control information of the above-described CQI/PMI/RI, etc. through a PUSCH and/or a PUCCH.

Table 5 represents an example of a DCI format in an NR system.

TABLE 5

| DCI Format | Use |
|---|---|
| 0_0 | Scheduling of a PUSCH in one cell |
| 0_1 | Scheduling of one or multiple PUSCHs in one cell, |
| | or indication of cell group downlink feedback |
| | information to a UE |
| 0_2 | Scheduling of a PUSCH in one cell |
| 1_0 | Scheduling of a PDSCH in one DL cell |
| 1_1 | Scheduling of a PDSCH in one cell |
| 1_2 | Scheduling of a PDSCH in one cell |

In reference to Table 5, DCI formats 0_0, 0_1 and 0_2 may include resource information (e.g., UL/SUL (Supplementary UL), frequency resource allocation, time resource allocation, frequency hopping, etc.), information related to a transport block (TB) (e.g., MCS (Modulation and Coding Scheme), a NDI (New Data Indicator), a RV (Redundancy Version), etc.), information related to a HARQ (Hybrid-Automatic Repeat and request) (e.g., a process number, a DAI (Downlink Assignment Index), PDSCH-HARQ feedback timing, etc.), information related to multiple antennas (e.g., DMRS sequence initialization information, an antenna port, a CSI request, etc.), power control information (e.g., PUSCH power control, etc.) related to scheduling of a PUSCH and control information included in each DCI format may be pre-defined. DCI format 0_0 is used for scheduling of a PUSCH in one cell. Information included in DCI format 0_0 is CRC (cyclic redundancy check) scrambled by a C-RNTI (Cell Radio Network Temporary Identifier) or a CS-RNTI (Configured Scheduling RNTI) or a MCS-C-RNTI (Modulation Coding Scheme Cell RNTI) and transmitted. DCI format 0_1 is used to indicate scheduling of one or more PUSCHs or configure grant (CG) downlink feedback information to a terminal in one cell. Information included in DCI format 0_1 is CRC scrambled by a C-RNTI or a CS-RNTI or a SP-CSI-RNTI (Semi-Persistent CSI RNTI) or a MCS-C-RNTI and transmitted. DCI format 0_2 is used for scheduling of a PUSCH in one cell. Information included in DCI format 0_2 is CRC scrambled by a C-RNTI or a CS-RNTI or a SP-CSI-RNTI or a MCS-C-RNTI and transmitted.

Next, DCI formats 1_0, 1_1 and 1_2 may include resource information (e.g., frequency resource allocation, time resource allocation, VRB (virtual resource block)-PRB (physical resource block) mapping, etc.), information related to a transport block (TB) (e.g., MCS, NDI, RV, etc.), information related to a HARQ (e.g., a process number, DAI, PDSCH-HARQ feedback timing, etc.), information related to multiple antennas (e.g., an antenna port, a TCI (transmission configuration indicator), a SRS (sounding reference signal) request, etc.), information related to a PUCCH (e.g., PUCCH power control, a PUCCH resource indicator, etc.) related to scheduling of a PDSCH and control information included in each DCI format may be pre-defined.

DCI format 1_0 is used for scheduling of a PDSCH in one DL cell. Information included in DCI format 1_0 is CRC scrambled by a C-RNTI or a CS-RNTI or a MCS-C-RNTI and transmitted.

DCI format 1_1 is used for scheduling of a PDSCH in one cell. Information included in DCI format 1_1 is CRC scrambled by a C-RNTI or a CS-RNTI or a MCS-C-RNTI and transmitted.

DCI format 1_2 is used for scheduling of a PDSCH in one cell. Information included in DCI format 1_2 is CRC scrambled by a C-RNTI or a CS-RNTI or a MCS-C-RNTI and transmitted.

### Wireless Communication System Supporting Non-Terrestrial Network (NTN)

A NTN refers to a segment of a network or a network configured to use a radio resource (RF resource) in an unmanned aircraft system (UAS) platform or a satellite. In order to secure a wider coverage or provide a wireless communication service in a place where it is not easy to install a wireless communication base station, use of a NTN service is considered.

Here, a NTN service refers to providing a wireless communication service to terminals by installing a base station on an artificial satellite (e.g., a geostationary-orbit, low-orbit, medium-orbit satellite, etc.), an airplane, an unmanned airship, a drone, etc., not on the ground. In the following description, a NTN service may include a NR NTN service and/or a LTE NTN service. A terrestrial network (TN) service refers to providing a wireless communication service to terminals by installing a base station on the ground.

A frequency band considered for a NTN service may be mainly a 2 GHz band (S-band: 2-4 GHz) in a first frequency range (frequency range 1, FR1) (e.g., 410 MHz to 7.125 GHz) and a downlink 20 GHz, uplink 30 GHz band (Ka-Band: 26.5˜40 GHz)) in a second frequency range (frequency range 2, FR2) (e.g., 24.25 GHz to 52.6 GHz). Additionally, a NTN service may be also supported in a frequency band between 7.125 GHz and 24.25 GHz or in a frequency band equal to or greater than 52.6 GHz.

FIG. 7 is a diagram for describing a NTN supported by a wireless communication system to which the present disclosure may be applied.

FIG. 7(a) illustrates a NTN scenario based on a transparent payload and FIG. 7(b) illustrates a NTN scenario based on a regenerative payload.

Here, a NTN scenario based on a transparent payload is a scenario that an artificial satellite receiving a payload from a base station on the ground transmits a corresponding payload to a terminal and a NTN scenario based on a regenerative payload refers to a scenario that an artificial satellite is implemented as a base station (gNB).

A NTN is generally characterized by the following elements.
At least one sat-gateway for connecting a NTN to a common data network:

A geostationary earth orbiting (GEO) satellite is supplied by at least one sat-gateway arranged in a coverage targeted by a satellite (e.g., a regional or continental coverage). It may be assumed that a terminal in a cell is served by only one sat-gateway.

A non-GEO satellite may be successively served by at least one sat-gateway. In this case, a wireless communication system guarantees service and feeder link continuity between serving sat-gateways during a time duration enough to perform mobility anchoring and handover.
Feeder link or radio link between a sat-gateway and a satellite (or a UAS platform)
Service link or radio link between a terminal and a satellite (or a UAS platform)
Satellite (or UAS platform) which may implement one of a transparent or regenerative payload (including on-board processing)

Satellite (or UAS platform) generation beams generally generate a plurality of beams in a service region where a boundary is designated by a view of a satellite (or a UAS platform). A footprint of a beam is generally elliptical. A view of a satellite (or a UAS platform) is determined by an on-board antenna diagram and a minimum altitude angle.

Transparent payload: Radio frequency filtering, frequency conversion and amplification. Accordingly, a waveform signal repeated by a payload is not changed.

Regenerative payload: Demodulation/decoding, switching and/or routing, coding/modulation as well as radio frequency filtering, frequency conversion and amplification. It is substantially the same as having all or part of base station functions (e.g., gNB) in a satellite (or a UAS platform).
For a satellite group, ISL (Inter-satellite links). For it, a regenerative payload is required for a satellite. ISLs may operate in a RF frequency or a broadband.
A terminal is serviced by a satellite (or a UAS platform) in a target service region.

Table 6 illustrates types of a satellite (or a UAS platform).

TABLE 6

| | Altitudinal | | | General Beam | |
|---|---|---|---|---|---|
| Platform | Range | | Orbit | Footprint Size | |
| Low-earth | 300-1500 | km | Circular around | 100-1000 | km |
| Orbiting | | | the Earth | | |
| Satellite | | | | | |
| Medium-earth | 7000-25000 | km | | 100-1000 | km |
| Orbiting | | | | | |
| Satellite | | | | | |
| Geostationary | 35,786 | km | Notional Station | 200-3500 | km |
| Earth Orbiting | | | which maintains | | |
| Satellite | | | a fixed position | | |
| UAS Platform | 8-50 km | | at an altitude/ | 5-200 | km |
| (including | (20 km for HAPS) | | azimuth for a | | |
| HAPS) | | | given earth point | | |
| High Elliptical | 400-50000 | km | Elliptical around | 200-3500 | km |
| Orbiting | | | the Earth | | |
| Satellite | | | | | |

Generally, a GEO satellite and a UAS are used to provide a continental, regional or local service. And, a constellation of LEO (low earth orbiting) and MEO (medium earth orbiting) is used to provide a service in both the northern hemisphere and the southern hemisphere. Alternatively, a corresponding constellation may provide a global coverage including a polar region. Subsequently, a proper orbital inclination, a generated sufficient beam and an inter-satellite link may be required. And, a HEO (Highly Elliptical Orbiting) satellite system may be also considered.

Hereinafter, a wireless communication system in a NTN including the following 6 reference scenarios is described.
Circular orbit and notational station keeping up platform
Highest RTD (Round Trip Delay) constraint
Highest Doppler Constraint
Transparent or regenerative payload
1 ISL Case and 1 Case without a ISL For an inter-satellite link, regenerative payload

The following 6 reference scenarios are considered in Table 7 and Table 8.

TABLE 7

| | Transparent | Regenerative |
|---|---|---|
| | Satellite | Satellite |
| GEO-based Non-terrestrial | Scenario A | Scenario B |
| Access Network | | |
| LEO-based Non-terrestrial | Scenario C1 | Scenario D1 |
| Access Network: Steerable | | |
| Beams | | |
| LEO-based Non-terrestrial | Scenario C2 | Scenario D2 |
| Access Network: | | |
| Corresponding beams | | |
| move with a satellite. | | |

TABLE 8

| Scenario | GEO-based Non- | | LEO-based Non-terrestrial Access Network |
|---|---|---|---|
| | terrestrial Access | | (Scenario C and D) |
| | Network (Scenario | | |
| | A and B) | | |
| Orbit Type | Notional Station | | Circular around the Earth |
| | which maintains a | | |
| | fixed position at an | | |
| | altitude/azimuth for | | |
| | a given earth point | | |
| Altitude | 35,786 | km | 600 km, 1,200 km |
| Spectrum | In FR1 (e.g., 2 GHz) | | |
| (Service Link) | In FR2 (e.g., DL 20 GHz, UL 30 GHz) | | |
| Maximum Channel | In FR1, 30 MHz | | |
| Bandwidth Capability | In FR2, 1 GHz | | |
| (Service Link) | | | |
| Payload | Scenario A: | | Scenario C: Transparent (including only a |
| | Transparent | | radio frequency function) |
| | (including only a | | Scenario D: Regenerative (including all or |
| | radio frequency | | part of RAN functions) |
| | function) | | |
| | Scenario B: | | |
| | Regenerative | | |
| | (including all or part | | |
| | of RAN functions) | | |
| Inter-satellite Link | No | | Scenario C: No Scenario D: Yes/No |
| | | | (Both two cases are available) |
| Earth-fixed Beam | Yes | | Scenario C1: Yes (Steerable Beams) |
| | | | (Reference 1), Scenario C2: No |
| | | | (Corresponding beams move with a satellite) |
| | | | Scenario D1: Yes (Steerable Beams) |
| | | | (Reference 1), |
| | | | Scenario D2: No (Corresponding beams |
| | | | move with a satellite) |
| Maximum Beam | 3500 | km | 1000 km |
| Footprint Size (edge- | (Reference 5) | | |
| to-edge) irrelevant to | | | |
| Elevation Angle | | | |
| Minimum Elevation | 10° for Service Link | | 10° for Service Link |
| Angle for both Sat- | 10° for Feeder Link | | 10° for Feeder Link |
| Gateway and Terminal | | | |
| Maximum Distance | 40581 | km | 1,932 km (Altitude of 600 km) |
| between Satellite and | | | 3,131 km (Altitude of 1,200 km) |
| Terminal at Minimum | | | |
| Elevation Angle | | | |
| Maximum Round Trip | Scenario A: | | Scenario C: (Transparent Payload: Service |
| Delay (only | 541.46 ms | | and Feeder Link) |
| Propagation Delay) | (Service and | | 25.77 ms (600 km) |
| | Feeder Link) | | 41.77 ms (1200 km) |
| | Scenario B: | | Scenario D: (Regenerative Payload: Only |
| | 270.73 ms | | Service Link) |
| | (only Service Link) | | 12.89 ms (600 km) |
| | | | 20.89 ms (1200 km) |
| Maximum Differential | 10.3 | ms | For each of 600 km and 1200 km, 3.12 ms and |
| Delay in Cell | | | 3.18 ms |
| (Reference 6) | | | |
| Maximum Doppler | 0.93 | ppm | 24 ppm (600 km) 21 ppm (1200 km) |
| Shift (Earth-fixed | | | |
| Terminal) | | | |
| Maximum Doppler | 0.000045 | ppm/s | 0.27 ppm/s (600 km) 0.13 ppm/s (1200 km) |

| Shift Variation (Earth- | | |
|---|---|---|
| fixed Terminal) | | |
| Movement of Terminal | 1200 km/h | 500 km/h (e.g., High-speed Train), Possible |
| on the Earth | (e.g., Aircraft) | 1200 km/h (e.g., Aircraft) |
| Terminal Antenna Type | Omnidirectional Antenna (Linear Polarization), Assumed to be 0 dBi | |
| | Directional Antenna (Aperture Diameter of up to 60 cm in Circular | |
| | Polarization) | |
| Terminal Transmission | Omnidirectional Antenna UE Power Class 3 Directional Antenna of | |
| (Tx) Power | up to 200 mW: Up to 20 W | |
| Terminal Noise Level | Omnidirectional Antenna: 7 dB Directional Antenna: 1.2 dB | |
| Service Link | Link defined in 3GPP | |
| Feeder Link | Radio Interface | Radio Interface defined in 3GPP or |
| | defined in 3GPP or | non-3GPP |
| | non-3GPP | |

Reference 1: Each satellite may use a beamforming technology to steer a beam to a fixed point on earth. It is applied for a time corresponding to a visibility time of a satellite. Reference 2: The maximum delay variation in a beam (a terminal fixed on earth (or on the ground)) is calculated based on the minimum elevation angle for both a gateway and a terminal.

Reference 3: The maximum differential delay in a beam is calculated based on a diameter of the maximum beam reception scope at nadir.

Reference 4: Speed of light used for delay calculation is 299792458 m/s.

Reference 5: A size of the maximum beam reception scope of GEO is determined based on a GEO high throughput system technology of a current state by assuming that there is a spot beam at a coverage edge (low altitude).

Reference 6: The maximum differential delay at a cell level is calculated by considering a delay at a beam level for the largest beam size. When a beam size is small or medium, a cell may include at least two beams. But, a cumulative differential delay of all beams in a cell does not exceed the maximum differential delay at a cell level of Table 8.

A NTN-related description in the present disclosure may be applied to a NTN GEO scenario and all NGSO (non-geostationary orbit) scenarios having a circular orbit with an altitude of 600 km or more.

And, the description (a NR frame structure, a NTN, etc.) may be applied in combination of methods which will be described later, and may be supplemented to clarify a technical characteristic of a method described in the present disclosure.

### Method of Configuring TA (Timing Advance) Value in NTN

In a TN, a terminal moves in a cell, so although a distance between a base station and a terminal changes, a PRACH preamble transmitted by a terminal may be transmitted to a base station within a time duration of a specific RO (RACH occasion).

And, a TA value for transmitting an uplink signal/channel by a terminal may be configured with an initial TA value and a TA offset value. Here, an initial TA value and a TA offset value may be indicated by a base station as a TA value which may be expressed in a cell coverage scope of a base station.

In another example, when a base station indicates a PDCCH order through DCI, a terminal may transmit a PRACH preamble to a base station. A terminal may transmit an uplink signal/channel to a base station by using a TA value (i.e., an initial TA value) indicated through a response message for a preamble received from a base station (random access response, RAR).

In a NTN, a distance between a satellite and a terminal is changed by movement of a satellite regardless of movement of a terminal. In order to overcome it, a terminal may figure out a position of a terminal through a GNSS (global navigation satellite system) and calculate a UE-specific TA, a round trip delay (RTD) between a terminal and a satellite, through orbit information of a satellite indicated by a base station.

Here, a UE-specific TA, when a PRACH preamble is transmitted at a RO selected by a terminal, may be configured so that a satellite (or a base station (gNB)) may receive a PRACH preamble within a time duration of the RO.

And, when only a UE-specific TA is applied when a PRACH preamble is transmitted at a RO selected by a terminal, the PRACH preamble may be delayed from a reference time of the RO and transmitted to a satellite (or gNB). In this case, an initial TA value indicated by a RAR received from a base station may indicate the delayed value.

Additionally, a common TA may refer to a RTD between a satellite and gNB (or a reference point) on the ground. Here, a reference point may refer to a place where a downlink and uplink frame boundary matches. And, a common TA may be defined as being indicated by a base station to a terminal. If a reference point is in a satellite, a common TA may not be indicated and if a reference point is in gNB on the ground, a common TA may be used to compensate a RTD between a satellite and gNB.

Additionally, in a NTN, a TA value before transmission of message (Msg) 1 (e.g., a PRACH preamble)/Msg A (a PRACH preamble and a PUSCH) may be configured as a UE-specific TA and a common TA (if provided). Here, a UE-specific TA, as described above, may be a RTD between a satellite and a terminal calculated by a terminal itself.

As an embodiment of the present disclosure, FIG. 8 illustrates a method of calculating a TA value in a wireless communication system supporting a NTN.

FIG. 8(a) illustrates a regenerative payload-based NTN scenario. A common TA (Tcom) (common to all terminals) may be calculated by 2D0 (a distance between a satellite and a reference signal)/c and a UE-specific differential TA (TUEx) for a x-th terminal (UEx) may be calculated by 2 (D1x-DO)/c. The Total TA (Tfull) may be calculated by ‘Tcom+TUEx’. Here, D1x may refer to a distance between a satellite and UEx. Here, c may represent speed of light.

FIG. 8(b) illustrates a transparent payload-based NTN scenario. A common TA (Tcom) (common to all terminals) may be calculated by 2 (D01+D02)/c and a UE-specific differential TA (TUEx) for a x-th terminal (UEx) may be calculated by 2 (D1x-D0)/c. The Total TA (Tfull) may be calculated by ‘Tcom+TUEx’. Here, D01 may refer to a distance between a satellite and a reference point and D02 may refer to a distance between a satellite and a base station on the ground.

### Reference Adjustment for Time/Frequency Applied to NTN Uplink Transmission or Reception

In the present disclosure, examples for adjustment for a time reference and/or a frequency reference related to uplink transmission of a NTN terminal and uplink reception of a base station are described. First, examples for adjustment (or update) of a time reference are described and examples that a terminal reports information related to a time reference to a base station are described. Next, examples for adjustment (or update) of a frequency reference are described.

### Embodiment 1

This embodiment is about adjustment or update of a time reference related to uplink transmission or reception of a NTN system.

When a NTN terminal configures a time reference for uplink transmission, a terminal itself may calculate (or adjust, acquire, or update) a time reference based on information provided from a base station and apply it to uplink transmission. In order for a base station to successfully receive uplink transmission from a terminal, a base station may be required to receive a report from a terminal about a time reference calculated by a terminal itself.

A NTN terminal may adjust or update a time reference applied to uplink transmission. For example, a time reference may correspond to a TA offset or may correspond to a TA value that a TA offset is applied to an initial or most recent TA. Updating a time reference may include calculating or acquiring a current TA or may include applying a calculated/acquired TA.

In addition, a NTN terminal may report to a base station information on a time reference applied to uplink transmission. Reported information on a time reference may include a current TA value calculated/acquired by a terminal or may include a TA offset for deriving a current TA value.

An updated or reported time reference may include at least one of a UE-specific TA or a common TA.

Update of a time reference in a terminal may be initiated or triggered by a terminal (or triggered on an event basis). In addition, update of a time reference in a terminal may be initiated or triggered by a base station.

A terminal performing update for a time reference may correspond to a terminal of a connection mode (e.g., a RRC_connected mode). In the following examples, it is described by assuming a TA as a representative example of a time reference.

For example, a NTN terminal entering a connection mode needs to update a UE-specific TA calculated and acquired by a terminal itself in the past and/or a common TA indicated from a base station and others. Here, a terminal may trigger TA update or a base station may trigger TA update.

### Embodiment 1-1

This embodiment is about TA update triggered/initiated by a terminal.

For example, when a predetermined event occurs, a terminal may update a UE-specific TA. When a predetermined event occurs, it may correspond to a case in which a predetermined matric satisfies a specific condition. For example, a predetermined matric may be defined based on a UE-specific TA threshold, a UE-specific TA offset threshold, a RSRP/SINR variance, or a K-offset standard, etc. In addition, even when an uplink transmission timing based on a specific timing offset is not valid, it may correspond to occurrence of a predetermined event. A standard (e.g., a threshold) determining whether a predetermined event occurs may be preconfigured by a base station to a terminal or may be predefined without separate signaling between a base station and a terminal.

When a predetermined event occurs, a terminal may report TA update to a base station. Alternatively, although a predetermined event occurs, a terminal may perform TA update when permitted/allowed by a base station and may report to a base station information on an updated TA.

For an updated UE-specific TA value, an application time, an application procedure, etc. may be defined differently according to whether a terminal reports TA update.

According to this embodiment as such, a terminal may update and/or report a TA in an event-triggered way. Accordingly, even without additional signaling including a base station indicating TA update to a terminal and others, TA update in a terminal may be performed and information on an updated TA may be reported to a base station.

Specific examples for TA update/reporting triggered by a terminal are as follows.

When TA update is performed by a terminal-triggering method, a timing window for monitoring a synchronization source (e.g., GNSS signaling) during a connection mode of a terminal may be given from a base station. A corresponding timing window may be predefined or may be indicated by a base station through system information (e.g., a SIB) or RRC signaling, etc.

For example, when a frequency band that a terminal receives a GNSS signal is the same as a frequency band that a terminal receives NTN control information/data, the timing window may be configured/indicated for a time required for monitoring a general GNSS signal. Alternatively, when a frequency band that a terminal receives a GNSS is different from a frequency band that a terminal receives NTN control information/data, an additional processing time for a RF change is required, so a timing window value may be configured/indicated to be greater compared to a case in which a GNSS frequency band is the same as a NTN frequency band. A corresponding timing window value may be configured/indicated to a terminal based on an absolute time or the number of DL/UL slots.

When a predetermined event occurs, a terminal may be configured to start TA update. For example, a terminal may figure out its position information while monitoring GNSS signaling in the timing window. When satisfying a predefined specific matric (or satisfying a predetermined condition for a specific matric), a terminal may be configured to start update of a UE-specific TA.

Here, a specific matric may be a UE-specific TA value or a specific threshold therefor. Additionally or alternatively, a specific matric may be an offset of a UE-specific TA (e.g., a TA variance for an initial TA or a most recent TA) or a specific threshold therefor. Additionally or alternatively, a specific matric may be a variance for RSRP or a variance for SINR or a specific threshold therefor. Additionally or alternatively, a specific matric may be a difference between a predetermined or desired K-offset value and an offset (e.g., K-offset) value implicitly acquired through an initial TA (i.e., a sum of a common TA and a UE-specific TA), etc. or a threshold therefor.

For example, when a difference between a desired K-offset value and an implicitly acquired K-offset value exceeds a K1 parameter value indicated from a base station, UE-specific TA update may be performed. Here, when a RACH procedure is triggered by a PDCCH order, a K-offset allows a terminal to select the next available RACH occasion (RO) after K-offset slots from an end time of uplink slot n corresponding to downlink slot n that a PDCCH order is received, and it is for timing alignment between a base station and a terminal in a NTN service. In addition, a K1 parameter is a parameter which indicates an offset from a downlink slot that a PDSCH is transmitted to an uplink slot for HARQ-ACK feedback transmission for a corresponding PDSCH.

Additionally or alternatively, occurrence of a predetermined event may correspond to a case in which an uplink transmission timing of a terminal determined based on a configuration/an indication of a base station is not actually valid from a viewpoint of a terminal. For example, for an uplink transmission timing of a terminal, a base station may configure/indicate the above-described K-offset to a terminal. Together or separately, for an uplink transmission timing of a terminal, a base station may configure/indicate to a terminal a timing offset which is additionally applied to the minimum gap applied based on an end time of downlink slot n that a PDCCH order is received. For example, the minimum gap, for a RACH procedure triggered by a PDCCH order, may correspond to a sum of a time corresponding to a physical uplink shared channel (PUSCH) preparation time, a bandwidth part (BWP) switching delay time, a delay time predefined according to a frequency range (FR), and a switching gap time. The additionally applied timing offset may have a value for timing alignment between a base station and a terminal for a purpose similar to a K-offset. In this way, when a terminal determines a transmission time of an uplink signal/channel by reflecting timing-related information provided by a base station (e.g., a timing offset which is additionally applied to the K-offset and/or the minimum gap), but transmission of an uplink signal/channel is not valid at a corresponding time from a viewpoint of a terminal, it may be determined that the predetermined event occurred. For example, a case in which it is not valid may include a case in which a time determined based on timing-related information provided by a base station corresponds to the past than a current time, a case in which a K-offset and/or TA value calculated/updated in a terminal is greater than a K-offset and/or TA value provided by a base station, a case in which a K-offset value provided by a base station is smaller than an initial TA (i.e., a sum of a common TA and a UE-specific TA) value of a terminal and others. Since examples of such a predetermined event may occur because a timing-related value configured/indicated by a base station is proper, but it is a value that a UE-specific TA possessed by a terminal is based on a past situation/position of a terminal, i.e., an outdated value, they may correspond to a case in which a terminal needs to update a UE-specific TA value. As such, when a predetermined event occurs, a terminal may be configured to be triggered to update a UE-specific TA value.

In the above-described examples, when a terminal is configured to update a UE-specific TA value based on a predetermined event, a terminal may report to a base station that TA update was performed (or information related to a UE-specific TA). Alternatively, whether TA update is triggered may be determined by a terminal and a terminal may be configured to update a UE-specific TA under permission of a base station. For example, when a predetermined event occurs (or when a predefined specific matric is satisfied), a terminal may report to a base station that a UE-specific TA will be updated (or needs to be updated) and when a base station permits it (e.g., gives an indication to a terminal through a predetermined field, etc. in DCI), a terminal may be configured to update a UE-specific TA.

As an additional example, when a terminal performs TA update based on event-trigger, a time when an updated UE-specific TA value is applied may be defined. If a terminal reports an updated UE-specific TA value to a base station, a base station may indicate a new K-offset value based on a corresponding updated UE-specific TA value. Alternatively, when a terminal does not report an updated UE-specific TA value, a time when a new K-offset value is applied should be determined. In an example, after a terminal updates a UE-specific TA value (when it does not report anything to a base station), a terminal may be configured to perform a RACH procedure. A base station may newly indicate a proper TA command (TAC) through a RAR by receiving a PRACH preamble transmitted by a corresponding terminal and a terminal may be configured to transmit or receive control information/data by applying a new K-offset value which is implicitly acquired from an updated TA value after performing such a step.

### Embodiment 1-2

This embodiment is about TA update triggered/initiated by a base station.

A base station may not figure out information requiring a TA change including a position of a terminal, etc. in real time, so a terminal may be configured to perform TA update according to a predetermined TA timer, a predetermined TA update period, and/or a TA update indication method.

For example, a TA timer may be applied as a standard for determining validity for the total TA (i.e., a sum of a TA offset value by a TAC and an initial TA (i.e., a sum of a common TA and a UE-specific TA)). Alternatively, a TA timer may be applied as a standard for determining validity for a TA offset value by a TAC and an additional TA timer for a common TA and/or a UE-specific TA may be newly defined.

For example, a base station may indicate an update period of a UE-specific TA (e.g., a SIB or dedicated RRC signaling, etc.) and may indicate a TA update period with satellite orbit information (e.g., a bitmap method, etc.).

For example, for a specific terminal or a specific terminal group, whether a UE-specific TA is updated or whether a common TA and a UE-specific TA are updated may be indicated (e.g., through RRC, a MAC CE and/or DCI). According to an indication of a base station, a terminal may update a UE-specific TA and transmit a PRACH preamble based on an initial TA (i.e., a sum of a common TA and a UE-specific TA) reflecting an updated UE-specific TA. For it, a time duration for calculating a UE-specific TA and GNSS monitoring may be preconfigured or predefined/pre-promised between a base station and a terminal, and if a terminal does not perform UE-specific TA update, the time duration is not required, so it may be ignored.

Specific examples for TA update/reporting triggered by a base station are as follows.

First, examples for a TA timer are described.

According to a TA timer in the existing NR/LTE system, a TA value (or a TA offset value) indicated by a base station through a TAC field, etc. may be assumed by a terminal as being valid until a TA timer is expired and may be applied as a standard for performing uplink signal/channel transmission. In a NTN system, even excluding a TA value indicated by a base station through a TAC field, a UE-specific TA directly calculated by a terminal and a common TA indicated by a base station exist, so it is required to improve a TA timer such as the existing NR/LTE.

As a first example, a TA timer used in the existing NR/LTE may be reused (or replaced) for a purpose of determining validity of the total TA value. In this case, the total TA value correspond to a value obtained by adding all values indicated by a common TA (if provided by a base station), a UE-specific TA, and a TAC. In other words, the TA value refers to a TA value which is actually used by a terminal in a connection mode for uplink signal/channel transmission. Accordingly, there is an advantage of performing TA update through one TA timer without increasing the number of TA timers. Meanwhile, validity of all TA offset values indicated by a common TA, a UE-specific TA, and a TAC is determined by one TA timer, so a base station should provide a common TA for a terminal every time before a TA timer is expired and a signaling overhead that a terminal newly calculates a UE-specific TA according to a corresponding time may also increase.

As a second example, a TA timer used in the existing NT/LTE may be applied only to a value (or a TA offset value) indicated through a TAC field in the same way as before and at least one additional TA timer may be newly defined. An additional TA timer may be at least one of a TA timer for a common TA, a TA timer for a UE-specific TA, or a TA timer for a common TA and a UE-specific TA. Accordingly, validity for each of at least one of TA elements (i.e., a value indicated by a common TA, a UE-specific TA, or a TAC) may be determined through each TA timer. Accordingly, a base station may configure for a terminal a separate TA timer value for each TA element. For example, a first TA timer for a common TA and a UE-specific TA may be configured to be longer than a second TA timer for a value indicated by a TAC. Accordingly, it may be configured/indicated to update a TA value when a distance between a reference point and a satellite and/or a distance between a terminal and a satellite is significantly changed and a base station may be configured/indicated to frequently update a corresponding value (e.g., a TA offset value) through a TAC field of DCI.

A TA timer for each TA element (or a combination thereof) or for the total TA in the above-described examples may be reset as a value configured/indicated by a base station (or an initial value, or a default value) after a TA is updated.

A TA update period is described below.

A base station may configure/indicate a TA update period to a terminal. In an example, an update period of a UE-specific TA value which is directly calculated by a NTN terminal may be configured/indicated by a base station to a terminal. In an example, an update period of the UE-specific TA value may be configured/indicated by a base station to a terminal through a SIB or dedicated RRC signaling. In this case, a terminal may be configured to update a UE-specific TA value according to an indicated period.

Additionally, orbit information of a satellite indicated by a base station may be indicated by including information related to UE-specific TA update (e.g., an update period, etc.). For example, a specific window duration may be configured and a UE-specific TA update time may be indicated by a bitmap, etc. during a corresponding window duration. For example, a specific window duration may include a plurality of sub time durations and whether UE-specific TA update is performed in each of a plurality of sub time durations may be indicated by a bit value at one bit position of a bitmap. As an additional example, update may be performed periodically (or based on a bitmap) within the specific window duration and semi-periodic update for deactivation may be applied after the specific window duration is expired.

Next, a method in which a base station directly indicates TA update is described.

A base station may directly configure/indicate TA update through a RRC configuration, a MAC CE, a PDCCH/DCI, a group-common (GC) PDCCH/DCI, etc. Accordingly, a TA update time of a terminal may be determined based on a time when a configuration/an indication by the base station is received.

In an example, update of a UE-specific TA may be indicated in a UE-specific (or UE group-specific) way through a DCI format. For example, a 1-bit field indicating whether UE-specific TA update is performed to a PDCCH order DCI format may be added or may be defined by reusing a bit value of the existing field. A base station may instruct a terminal to update a UE-specific TA through a corresponding 1-bit field. Alternatively, all terminals reading a corresponding PDCCH through a group-common PDCCH, etc. may be indicated to update a UE-specific TA value.

Additionally or alternatively, at a time when an updated common TA value is provided from a base station, a terminal may be configured to update a UE-specific TA value. For example, a common TA may be transmitted through DCI or a SIB, etc. or may be updated through a K-offset value. In other words, a terminal may consider an indication of a base station for common TA and/or K-offset update as an indication of updating a UE-specific TA. When a base station updates a common TA value to a terminal, it may correspond to a situation in which a distance from a reference point to a satellite is significantly changed and a common TA value change is required, and in this case, a distance from a terminal to a satellite is also highly likely to be significantly changed, so it may be desirable for a terminal to operate to update a UE-specific TA value according to a common TA (or K-offset) change/update time.

In the above-described examples, a base station may instruct a terminal to update a UE-specific TA through a PDCCH order DCI format. A terminal which received a PDCCH order may be configured to transmit a PRACH preamble by using an initial TA that a corresponding UE-specific TA is reflected after updating a UE-specific TA. When comparing the total processing time of a terminal according to this example with a processing time for a RACH procedure based on a PDCCH order of the existing NR, a time for a terminal to monitor a GNSS to update a UE-specific TA and a time required to calculate a UE-specific TA are additionally required. Accordingly, a pre-promised time duration between a base station and a terminal (e.g., a GNSS monitoring duration and/or a UE-specific TA update duration), etc. may be defined or a corresponding duration may be configured/indicated by a base station to a terminal through higher layer signaling, etc. A terminal may be configured to monitor a GNSS during a corresponding time duration, update a UE-specific TA and perform a RACH procedure by using a resource indicated by a base station.

Here, the time duration is required for a terminal performing a PDCCH order-based RACH procedure to update a UE-specific TA while performing a RACH procedure.

Accordingly, a terminal performing a PDCCH order-based RACH procedure while maintaining a recent UE-specific TA as it is without updating a UE-specific TA for any reason may not separately require the time duration. In this case, although a corresponding time duration is configured/indicated to a terminal from a base station, a terminal may be configured to ignore a corresponding configuration/indication.

### Embodiment 1-3

This embodiment includes examples of the present disclosure for TA reporting.

In reporting a value of a UE-specific TA and/or the total TA (i.e., a common TA and a UE-specific TA) value to a base station, a terminal may reduce a signaling overhead by reporting only part of an updated UE-specific TA. For example, a terminal may report to a base station only a difference value from a recently reported value (e.g., whether to increase or decrease and/or an increase or decrease value). A difference value from a recently reported TA value may be also referred to as a TA variance, a TA increase or decrease amount, or a TA offset value. For example, in reporting a TA first, a terminal in a connection mode may report to a base station only a difference value from a TA reporting value in an idle or inactive mode or may report the total TA value in first reporting and report only a difference value from a previous reporting value in subsequent reporting. For example, a difference value between a previously applied K-offset value and a K-offset value predicted from an updated TA may be reported. For example, a base station may preconfigure candidates (or states) of a reporting value of a terminal and a terminal may select and report a specific candidate. For example, a base station may configure a default UE-specific TA value and a terminal may report only a difference value from a default value.

This reporting operation of a UE-specific TA may be applied to a terminal performing initial access or may be also applied to a terminal in a connection mode.

When a terminal reports an updated UE-specific TA as described above, a base station may update a K-offset value based on it and inform it to a terminal.

Hereinafter, specific examples of a TA reporting method of a terminal are described.

When a terminal reports to a base station a UE-specific TA (or the total TA (i.e., a sum of a UE-specific TA and a common TA)), all updated UE-specific TAs (or the total TA) may be reported as in the above-described examples or only part of newly updated UE-specific TAs (or the total TA) may be reported to reduce a signaling overhead of a terminal.

In an example, a terminal may be configured to report to a base station a difference between an updated UE-specific TA (or the total TA) value and a recently reported UE-specific TA (or the total TA) value in a connection mode. Here, a terminal may be configured to report an increase amount (or a decrease amount) of a newly updated value compared to a recently reported value or additionally report increase or decrease along with a difference in a value (e.g., increase (+) or decrease (−)).

Additionally or alternatively, when a terminal reports first in a connection mode, a terminal may be configured to report only a difference between a UE-specific TA (or the total TA) value reported in an idle/inactive mode and a newly updated UE-specific TA (or the total TA). Alternatively, when a terminal entering a connection mode reports first in a connection mode, a terminal may be configured to report to a base station the total updated UE-specific TA (or the total TA) value or may be configured to report a difference value (or an increase or decrease amount) from an updated UE-specific TA (or the total TA) compared to a recently reported UE-specific TA (or the total TA) value from subsequent reporting.

Additionally or alternatively, a terminal may be configured to report a difference between a K-offset value transmitted from a base station (i.e., a K-offset value which is applied until recently) and a K-offset value predicted from a UE-specific TA (or the total TA) value updated by a terminal. One purpose of a terminal reporting an updated TA is for a base station to adjust or update a K-offset value based on an updated TA. Accordingly, a terminal may be configured to report a difference value between a K-offset value previously configured/indicated by a base station and a new K-offset value predicted based on a newly updated TA value in a terminal.

Additionally or alternatively, a base station may preconfigure or predefine a value which may be reported by a terminal regarding TA update (e.g., candidate(s) or state(s)). In other words, a base station may preconfigure/pre-indicate a set of value(s) which may be reported by a terminal through signaling such as a SIB/RRC/a MAC-CE, etc. according to a bit size of signaling reported by a terminal (e.g., X-bit signaling). Alternatively, a set of value(s) which may be reported by a terminal may be predefined without signaling between a base station and a terminal. Accordingly, a terminal may be configured to select and report a candidate/state value corresponding to an updated UE-specific TA (or the total TA) value itself (or a difference value compared to a recently reported value).

Additionally or alternatively, information on an updated UE-specific TA (or the total TA) may be configured by a method of Y-bit signaling (e.g., for Y=2, one value of +10, +5, 0, −5 may be indicated). It may be said that this method is similar to CQI reporting for helping understanding only. Here, a Y value, a bit width (or a bit size) for corresponding reporting, may be configured/indicated by a base station to a terminal or may be predefined without signaling between a base station and a terminal. In addition, this example may be configured to be used when a specific TA is updated, not when a value of the total specific TA is reported (i.e., to report a difference value).

Additionally or alternatively, a base station may configure/indicate a cell-specific (or UE-specific, or UE group-specific) default UE-specific TA value and a terminal may be configured to report to a base station a difference between a corresponding default UE-specific TA value and a newly updated UE-specific TA value. For example, a default UE-specific TA value may be configured as the smallest UE-specific TA value that an any (or specific) terminal may have during a time served by a corresponding satellite. Accordingly, since a UE-specific TA value calculated by a terminal may be always the same as or greater than a default UE-specific TA, a reported value may become a positive value. Here, a default UE-specific TA value may be signaled with a common TA or may be signaled with satellite orbit information (e.g., satellite ephemeris information).

The above-described examples may be predefined (or supported in a standard) as candidates of a terminal operation reporting information on an updated TA. At least one of these candidates may be selected according to terminal preference, a capability or a user's configuration, etc. and information on a TA may be reported from a terminal to a base station according to a selected operation.

In the above-described examples, when a terminal reports a UE-specific TA (or the total TA), a base station may receive a corresponding value and update a K-offset. In other words, TA reporting of a terminal may be configured to trigger K-offset update of a base station. Subsequently, when a K-offset value updated by a base station is configured/indicated to a terminal, a terminal may perform UL/DL transmission or reception by using a corresponding updated K-offset value.

The above-described examples may be applied to a terminal in an idle/inactive mode or initial access or may be applied to a terminal in a connection mode.

### Embodiment 1-4

This embodiment includes additional examples for TA reporting.

In TA reporting, an absolute value of a TA may be reported at initial reporting and/or according to a specific period and a relative value of a TA (or a difference value compared to a recently reported TA or a current TA value) may be reported on an event basis. For example, a TA absolute value reporting period may be configured by a base station or a default period may be applied without separate signaling or may be reported only at initial reporting. For example, a reporting period of a TA absolute value and a reporting period of a TA relative value may be configured separately (e.g., equally or differently). For example, among reporting opportunities according to one reporting period, a TA absolute value may be reported in some opportunities and a TA relative value may be reported in the remaining opportunities.

A TA absolute value may be reported aperiodically. For example, when there is an indication of a base station, a TA absolute value may be reported from a terminal. For example, when a TA absolute value and a TA relative value are reported together (or simultaneously), a standard of a reported TA relative value may be a recently reported TA absolute value, and a reported TA absolute value may be a current (i.e., current before reporting of a terminal) TA absolute value being applied by a base station or a resulting TA absolute value to which a TA relative value reported together is applied.

When a terminal selects and reports at least one of a TA absolute value or a TA relative value, an indicator indicating whether a reported TA value is an absolute value or a relative value (or both) may be included in reported information.

A channel in which a terminal reports a TA absolute value and a channel in which a terminal reports a TA relative value may be configured separately/distinctly.

As such, after a terminal reports a TA value, a terminal may calculate the following reporting value based on a reported TA value after receiving ACK for TA reporting from a base station.

Hereinafter, specific examples of an additional method of TA reporting of a terminal are described.

In the above-described examples, when a terminal in an initial access process, an idle/inactive mode, or in a connection mode reports to a base station a UE-specific TA (or the total TA (i.e., a sum of a common TA and a UE-specific TA), or a K-offset, etc.), a signaling overhead is large if only an absolute value of reported TA information/parameter is always reported, so partial reporting (e.g., a differential value from a recently reported value) needs to be allowed/supported.

If a case is assumed in which only a difference value instead of an absolute value of TA parameter(s) is transmitted, when a base station may not accurately receive or detect a difference value reported from a terminal, it is impossible to acquire an accurate (absolute) value of a parameter that a terminal actually intends to report only with a difference value which will be reported from a terminal. Accordingly, in order to solve this problem, a terminal may be configured/indicated to report an absolute value of the TA parameter at a specific period. Here, a TA absolute value reporting period by a base station may be configured/indicated through higher layer signaling (e.g., a SIB, RRC, a MAC-CE, etc.) or a specific value which is a basis for calculating the period may be indicated or one of predefined candidate values may be configured/indicated.

For example, an absolute value of a TA parameter may be configured/indicated to a terminal to be reported at initial reporting and/or per (predefined or indicated) specific period. A difference value of a TA parameter may be configured/indicated to a terminal to be reported in other situation (e.g., event-triggered reporting, etc.).

Additionally or alternatively, when a period for reporting an absolute value from a base station is not configured/indicated, a terminal may be configured to report an absolute value per pre-promised default period (or predefined without signaling with a base station) or report an absolute value in first reporting of an initial access process or report an absolute value in first reporting after a terminal enters a connection mode or report a difference value in the remaining cases.

Additionally or alternatively, a period for reporting an absolute value and a period for reporting a difference value may be configured/indicated differently (or independently). For example, a period for reporting an absolute value may be configured/indicated as being long-term and a period for reporting a difference value may be configured/indicated as being short-term. Here, when an absolute value and a difference value should be reported simultaneously (e.g., within the same slot), a terminal may be configured to report both two values so that a base station may receive and determine both reporting. Alternatively, in order to reduce a signaling overhead of a terminal, a terminal may be configured to report only an absolute value including a current absolute value and a difference value to be reported (i.e., a difference to be reported is reflected in a current absolute value).

Additionally or alternatively, one period reporting a TA parameter (i.e., a period during which a TA absolute value and a TA difference value are not distinguished) may be configured from a base station to a terminal. In this case, a terminal may be configured to report an absolute value in some opportunities which have a pre-promised or larger period among a plurality of reporting opportunities according to a corresponding period. And, a terminal may be configured to report a difference value in the remaining opportunities excluding opportunities that an absolute value is reported.

Instead of a periodic TA reporting method, an aperiodic TA reporting method may be applied. For example, a terminal may be configured to report a TA absolute value only when a terminal is indicated by a base station to report a TA absolute value and report a difference value in other cases. Alternatively, a base station may configure/indicate a terminal to report a TA absolute value or configure/indicate a terminal to report a difference value or configure/indicate a terminal to report an absolute value and a difference value (or a sum thereof).

When a terminal reports a TA absolute value and a TA difference value at the same time, an absolute value which becomes a reference of a reported difference value may be a recent or current absolute value (i.e., as of a reporting time before a difference value is applied). A reference (or recent or current) absolute value may be an absolute value which is recently reported by a terminal (or most recently received successfully by a base station among values reported by a terminal (e.g., a terminal receives ACK)). In addition, a reported absolute value may be an absolute value currently acquired by a base station by adding previously reported difference value(s) to a reference absolute value. Alternatively, a reported absolute value may be an absolute value obtained by adding a reported difference value with previously reported difference value(s) to a reference absolute value. When a base station successfully receives both a TA absolute value and a relative value, a reference absolute value may be configured to be overridden (or replaced) with a newly reported absolute value (or successfully acquired by a base station).

For example, a case is assumed in which a TA absolute value first reported by a terminal is ABS_1, a TA difference value subsequently reported at a first reporting time is DIFF_1, a TA difference value reported at a second reporting time is DIFF_2, a TA difference value reported at a third reporting time is DIFF_3, a TA difference value reported at a fourth reporting time is DIFF 4 and both a TA absolute value and a TA difference value are reported at a fifth reporting time. For example, a terminal may report ABS_2 (=ABS_1+DIFF_1+DIFF_2+DIFF 3+DIFF_4) as an absolute value and report DIFF_5 as a difference value. According to other example, a terminal may report ABS_2′ (=ABS_1+DIFF_1+DIFF_2+DIFF 3+DIFF 4+DIFF_5) as an absolute value and report DIFF_5 as a difference value. When a base station successfully receives an absolute value and a relative value in both examples, a TA absolute value which is applied subsequently may become ABS_2′ (=ABS_1+DIFF 1+DIFF 2+DIFF_3+DIFF_4+DIFF_5).

When a terminal selects and reports one of an absolute value and a difference value or reports both an absolute value and a difference value, a base station may not know in advance whether a terminal reports an absolute value, report a difference value, or report both an absolute value and a difference value. In addition, a size of reporting information (or field) required for a case in which only an absolute value is reported, a case in which only a difference value is reported, or a case in which both an absolute value and a difference value are reported may be different. Accordingly, a field indicating a reporting type may be defined in a channel that TA reporting information/parameter is transmitted. For example, when a terminal selects and reports one of an absolute value or a difference value, a reporting type may be expressed by a 1-bit indicator. In addition, a bit width (or a bit size) of TA reporting information/parameter may be configured to vary depending on a reporting type.

In the above-described examples, an absolute value and/or a difference value may be reported to a base station through a dynamic/configured grant-based PUSCH (or a MAC CE), etc.

A physical channel that a terminal reports an absolute value and a difference value may be configured separately (or independently). For example, an absolute value may be reported through a first channel and a difference value may be reported through a second channel. A first channel and a second channel may be the same or different. For example, an absolute value may be configured to be reported through PUCCH format ¾, etc., which may support a relatively large size of uplink control information (UCI) and may be transmitted through a relatively large number of OFDM symbols. A difference value may be configured to be reported through PUCCH format 2, etc., which may support a relatively small size of UCI and may be transmitted through a relatively small number of OFDM symbols.

In the above-described examples, a reference absolute value which is a standard for a difference value may be configured to be an absolute value which is recently successfully received by a base station among values recently reported by a terminal or reported by a terminal. In order to prepare for a case in which a base station misses reporting of an absolute value, after a terminal receives ACK information representing that a terminal successfully received an absolute value from a base station after reporting an absolute value, a terminal may use a corresponding absolute value to perform uplink transmission and subsequent TA parameter reporting (e.g., reporting of a difference value or absolute value reporting at a subsequent reporting time).

### Embodiment 1-5

This embodiment includes additional examples for a condition for performing TA update/application/reporting. For example, Embodiment 1-5 may be applied in combination with an example of event-triggered TA update/reporting of Embodiment 1-1 (or as a detailed embodiment of Embodiment 1-1).

A terminal may perform UE-specific TA update if it is away from a recent (or last) uplink transmission time for more than a predetermined time.

As other example, UE-specific TA update may be performed based on a TA value, not a time.

For example, a terminal may acquire/calculate/update a UE-specific TA at a time of performing new uplink transmission (or immediately before uplink transmission). A terminal may update and report a UE-specific TA only when a difference from a recent UE-specific TA is equal to or greater than a predetermined threshold and if a difference is less than the threshold, a non-updated (i.e., a recent UE-specific TA) may be applied and accordingly, TA-related information may not be reported.

For example, a terminal may update and report a UE-specific TA only when a difference from a recent UE-specific TA is less than a predetermined threshold, and if a difference is equal to or greater than the threshold, a non-updated (i.e., a recent UE-specific TA) may be applied or a RACH may be newly performed to update a TA or a TA may be updated only by a predetermined amount.

For example, a terminal may not perform TA update/reporting if a difference from a recent TA is less than a first threshold, may perform TA update/reporting if a difference is equal to or greater than a first threshold and less than a second threshold and may not update a TA or may update a TA by a predetermined amount if a difference is equal to or greater than a second threshold.

For example, when one uplink transmission is performed for a long period of time, TA update/reporting may not be performed during corresponding uplink transmission. If a TA change may be predicted, TA update may be allowed during uplink transmission only under a shared condition between a base station and a terminal.

For example, an updated common TA may be applied to initial uplink transmission after a terminal receives an updated common TA value from a base station. More specifically, an updated common TA value may be applied to initial uplink transmission after a processing time (e.g., X msec) of a terminal elapses after receiving an updated common TA value. Even for a UE-specific TA, it may be configured to perform UE-specific TA update/reporting from a time before Y msec before new uplink transmission in consideration of a processing time of a terminal.

Specific examples for TA update/reporting are described below.

It is required to define an application time of updated TAs (e.g., UE-specific TAs, common TAs, etc.) according to a configuration/an indication of a terminal and/or a base station. An application time of an updated TA may include a time of updating a TA or a time of reporting an updated TA.

First, TA (specifically, UE-specific TA) update/application/reporting may be determined based on a time threshold.

For example, as a UE-specific TA is a TA value which is autonomously acquired by a terminal, it may be updated before uplink signal/channel transmission of a terminal. An updated TA may be configured to be applied immediately from a first slot (or a first subframe, or a first OFDM symbol) of corresponding uplink signal/channel transmission. But, when a terminal performs uplink signal/channel transmission frequently (e.g., per each uplink slot), new calculation of a UE-specific TA for every transmission may be a burden to a terminal. In addition, since a UE-specific TA value may not be changed significantly at a current time (i.e., a time of performing TA update right before uplink transmission) compared to a nearby previous time, a UE-specific TA value may be updated/reported when a time that a terminal intends to transmit a new uplink signal/channel (e.g., a first slot, a first subframe, a first OFDM symbol, etc. of new uplink transmission) is more than a specific time (e.g., a time threshold) away from a time of recent (or last) uplink signal/channel transmission (e.g., a first slot, a first subframe, a first OFDM symbol, etc. of recent uplink transmission), and it may be configured not to update/report a UE-specific TA value if it is less than a specific time away.

Next, TA (specifically, UE-specific TA) update/application/reporting may be determined based on a TA offset (or difference value) threshold.

For example, when a current UE-specific TA value acquired at a time when a terminal intends to transmit a new uplink signal/channel differs from a previous UE-specific TA value acquired (or successfully reported last) at a recent (or last) uplink signal/channel transmission time by over/exceeding a predetermined specific value (e.g., a TA offset threshold), it may be configured to update/report a UE-specific TA. When a current UE-specific TA value is less than/equal to or less than the predetermined specific value than a previous UE-specific TA value, a terminal may be configured to transmit a new uplink signal/channel by reusing a previous UE-specific TA value without updating a UE-specific TA.

For example, when a current UE-specific TA value acquired at a time when a terminal intends to transmit a new uplink signal/channel differs from a previous UE-specific TA value acquired (or successfully reported last) at a recent (or last) uplink signal/channel transmission time by below/less than a predetermined specific value (e.g., a TA offset threshold), it may be configured to update/report a UE-specific TA. When a current UE-specific TA value is equal to or greater than/exceeds the predetermined specific value than a previous UE-specific TA value, a terminal may be configured to transmit a new uplink signal/channel by reusing a previous UE-specific TA value without updating a UE-specific TA. Since a difference from a current UE-specific TA value is not large although a previous UE-specific TA value is reused, it may be expected that a major problem will not occur in uplink transmission or reception.

Here, when a current UE-specific TA value is equal to or greater than/exceeds the predetermined specific value than a previous UE-specific TA value, a terminal determines that a previous TA is no longer valid, but it may correspond to an operation for (indirectly) initiating a RACH procedure through transmission of a new uplink signal/channel (or through a failure in corresponding uplink transmission). Alternatively, when a current UE-specific TA value is equal to or greater than/exceeds the predetermined specific value than a previous UE-specific TA value, a terminal may be configured to directly initiate a RACH procedure without performing TA update/reporting and without performing new uplink transmission. As an additional example, when a current UE-specific TA value is equal to or greater than/exceeds the predetermined specific value than a previous UE-specific TA value, a terminal may be configured to transmit a new uplink signal/channel by updating a UE-specific TA (i.e., applying a UE-specific TA which is a result of adding/subtracting a TA offset threshold to/from a previous UE-specific TA, not a current UE-specific TA) only by the predetermined specific value (or, a TA offset threshold).

As an additional example, an operation using a plurality of the above-described TA offset thresholds may be defined. For example, a first threshold (Th1) is a relatively small/low threshold and may control a TA update frequency of a terminal. For example, as Th1 is higher, frequent TA update of a terminal may be prevented. A second threshold (Th2) is a relatively large/high threshold, and may control a possibility that a terminal initiates a RACH procedure by reflecting a range covered by a reception window of a base station. For example, as Th2 is lower, a possibility that a terminal initiates a RACH procedure may be increased.

For example, when a difference between a current UE-specific TA value acquired at a time when a terminal intends to transmit a new uplink signal/channel and a previous UE-specific TA value acquired (or last successfully reported) at a recent (or last) uplink signal/channel transmission time is below/equal to or less than Th1, it may be configured to perform uplink transmission by applying a previous UE-specific TA value without updating/reporting a UE-specific TA. When a difference between a current UE-specific TA value and a previous UE-specific TA value is equal to or greater than/exceeds Th1 and below/equal to or less than Th2, it may be configured to update/report a UE-specific TA. When a difference between a current UE-specific TA value and a previous UE-specific TA value is equal to or greater than/exceeds Th2, it may be configured to perform uplink transmission by applying a previous UE-specific TA without updating/reporting a UE-specific TA or initiate a RACH procedure without performing UE-specific TA update/reporting and uplink transmission or perform uplink transmission by updating/reporting a UE-specific TA only by a Th2 value.

As an additional example, it may be difficult for a base station to successfully receive uplink transmission when a TA is changed during uplink signal/channel transmission, so a terminal may be configured not to update a UE-specific TA (or not to perform open-loop TA control) during uplink signal/channel transmission. In other words, a terminal may be configured not to expect to update a UE-specific TA (or perform open-loop TA control) during specific uplink signal/channel transmission.

For a common TA, an updated TA parameter may be provided to a terminal through signaling from a base station (e.g., higher layer signaling (e.g., a SIB, RRC, a MAC CE, etc.)). A terminal may update a common TA by using a corresponding TA parameter. When a common TA is updated in this way, a terminal may be configured to apply an updated common TA value at a first uplink signal/channel transmission time (e.g., a first slot, a first subframe, a first OFDM symbol) after receiving the TA parameter signaling from a base station.

A terminal entering a connection mode may also apply an updated TA at an uplink signal/channel transmission time. When a change in a TA (e.g., at least one of a common TA or a UE-specific TA) over time is predicted in advance from a viewpoint of a terminal, a terminal may be configured to allow TA update during uplink signal/channel transmission. Here, it is desirable to update a TA during uplink signal/channel transmission only at a specific time which may be known in advance between a terminal and a base station. In an example, a terminal may be configured to apply an updated TA at a slot boundary (e.g., a first OFDM symbol of each slot) while transmitting a PUSCH across several slots. In another example, in consideration of channel estimation performance, it may be configured to use the same TA for a transmission duration using the same reference signal (e.g., a DMRS) and update a TA according to a time when a reference signal is changed. In order to support it, a base station may notify a terminal of whether TA update is allowed/supported in the middle of uplink signal/channel transmission through higher layer signaling. Additionally or alternatively, a base station may notify a terminal of a time when a TA will be updated and applied.

For the above-described examples, in applying an updated TA at a first uplink transmission time (e.g., a first slot, a first subframe or a first OFDM symbol of first uplink transmission) after receiving parameter signaling for an updated common TA from a base station, a processing time (e.g., a common TA decoding time) of a terminal may be additionally considered. Accordingly, a terminal may be defined as applying a newly updated TA from a first uplink signal/channel transmission time after X msec (or slots) from a time of receiving common TA parameter signaling from a base station. Here, X may have a value of 0 or a positive value, may be determined based on a capability of a terminal, or may be a value configured/indicated by a base station.

For a UE-specific TA, as described above, a UE-specific TA may be acquired before new uplink signal/channel transmission and an updated UE-specific TA may be reported/applied (according to a predetermined standard). Even in this case, a processing time of a terminal (e.g., a satellite orbit decoding time, and/or a UE-specific TA estimation time, etc.) may be considered. Accordingly, it may be configured to perform UE-specific TA update/reporting from a time at least Y msec (or slot) before a new uplink signal/channel transmission time (e.g., a first slot, a first subframe or a first OFDM symbol of new uplink transmission). Here, Y may have a value of 0 or a positive value, may be determined based on a capability of a terminal, or may be a value configured/indicated by a base station.

### Embodiment 1-6

This embodiment includes additional examples for TA reporting.

For example, a terminal may be configured to report a UE-specific TA according to a predetermined period or may be configured to report a UE-specific TA when a UE-specific TA is updated without following a period.

When a terminal is handed over between satellites, a terminal may be configured to update and report a UE-specific TA for each of a plurality of satellites.

Hereinafter, specific examples of TA reporting are described.

A NTN terminal entering a connection mode may update a previous UE-specific TA and/or a common TA indicated by a base station and others. In addition, a UE-specific TA may be updated according to a terminal initiation method (e.g., Embodiment 1-1) and/or a network/base station initiation method (e.g., Embodiment 1-2). When an uplink/downlink timing parameter such as a K-offset is determined implicitly (e.g., a K-offset value is derived from a UE-specific TA and a common TA), a base station may correctly predict a K-offset value of a corresponding terminal when a base station knows a UE-specific TA value updated by a terminal itself. Accordingly, a NTN terminal entering a connection mode needs to be configured to report a UE-specific TA periodically or semi-periodically (or on an event basis).

For example, a terminal may update a UE-specific TA and report an updated UE-specific TA according to a UE-specific TA update period indicated by a network (or at a time when a TA timer is expired). A terminal in a connection mode may be configured to report an updated UE-specific TA value to a network through an uplink signal/channel such as a PUSCH/a PUCCH/a SRSR, etc.

As another example, a terminal may be configured to report an updated UE-specific TA when a UE-specific TA is updated. For example, when a predetermined event occurs (or a predetermined metric is satisfied) (refer to Embodiment 1-1), a terminal may update/report a UE-specific TA. If it is not required to update a UE-specific TA frequently because a terminal or a satellite moves slowly, reporting of a UE-specific TA also does not need to be performed frequently, and conversely, if it is required to update a UE-specific TA frequently because a terminal or a satellite moves fast, reporting of a UE-specific TA needs to be performed frequently.

A network may calculate a K-offset value to be implicitly derived by a terminal based on a UE-specific TA value and a common TA value reported from a terminal and may perform an uplink/downlink signal/channel transmission or reception process based on it.

In addition, when there are two satellites connected to one base station, in order for a terminal to perform handover between satellites, a separate common TA value used by a corresponding base station per each satellite (i.e., a TA for compensating a RTD from a reference point to each satellite) and orbit information on each satellite may be broadcast or unicast through higher layer signaling. A terminal may figure out a position of a terminal through a GNSS and acquire a UE-specific TA for each satellite by using orbit information of satellites provided from a base station. A terminal may calculate the total TA (i.e., a sum of a common TA and a UE-specific TA) based on a common TA value corresponding to each satellite indicated by the base station and a UE-specific TA value for each satellite. Accordingly, it may be configured to perform a RACH process based on the total TA value calculated for a corresponding satellite for a target satellite of handover.

### Embodiment 2

This embodiment relates to adjustment or update of a frequency reference related to uplink transmission or reception of a NTN system.

Unlike a TA (timing advance) which is a representative example of a time reference adjustment value described in the above-described Embodiment 1 and sub-examples, in this embodiment, a FA (frequency advance) which is an adjustment value for a frequency reference is newly defined. Similar to a TA in a time domain, a FA may be applied as an adjustment value in a frequency domain. In addition, by notifying a terminal of oscillator information of a satellite, a terminal may adjust its own oscillator information (e.g., a frequency). A FA may be also referred to as information for adjusting frequency pre-compensation.

Specifically, a Doppler effect between a terminal and a satellite corresponding to a service link may be pre-compensated by using orbit information of a satellite and position information of a terminal obtained by a terminal through a GNSS. Here, when a frequency offset problem occurs due to a difference between a characteristic of a satellite oscillator and a characteristic of a terminal oscillator, the above-described pre-compensation may not be perfectly applied. In a network/a base station, a corresponding frequency offset error may be configured to be detectable, but if a corresponding frequency offset error is not corrected, there is a problem that an uplink/downlink signal/channel including a corresponding frequency offset error is inevitably transmitted or received between a terminal and a base station, so a solution therefor is required.

For example, a FAC (frequency advance command) may be indicated to a terminal. As a FAC means that an adjustment value similar to a TAC is applied to a frequency domain, it may correct a frequency offset errors and/or a Doppler effect on a feeder link (i.e., a link between a base station and a satellite). For example, a FA may correct a frequency offset error by giving an indication through a FAC field included in a RACH procedure (e.g., Msg.2 RAR for a 4-step RACH procedure or Msg.B RAR for a 2-step RACH procedure). In addition, similar to a TAC, candidate values that a FAC field may have are predefined, and a base station may correct a frequency offset error by indicating one of candidate values to a terminal. A terminal may apply an indicated FAC value to correct/reduce a frequency offset error for an uplink/downlink channel/signal transmitted or received from subsequent uplink transmission (e.g., PUSCH transmission in a RACH process).

Additionally or alternatively, in order to improve an effect of frequency pre-compensation, oscillator information of a satellite connected to a network may be informed to a terminal through higher layer signaling (e.g., a SIB, RRC, a MAC CE, etc.). Alternatively, when a base station indicates a frequency offset for correcting a Doppler effect of a feeder link, oscillator information of a corresponding satellite may be also indicated together. A terminal may more accurately perform frequency pre-compensation for a service link by calculating a difference between oscillator information of a satellite and oscillator information of a terminal itself. If a frequency offset for correcting a Doppler effect of a feeder link and oscillator information of a satellite are provided together, a terminal may also perform frequency pre-compensation for a feeder link. Since a terminal may perform frequency pre-compensation before RACH initiation (e.g., a Msg.1 PRACH for a 2-step RACH procedure, or a Msg. A PRACH/PUSCH for a 4-step RACH procedure), from a viewpoint of a base station, a frequency offset error may be reduced from RACH signal/channel detection.

The above-described embodiments may be included as one of implementation methods of the present disclosure. In addition, the above-described embodiments may be implemented independently, but may be also implemented in a combination (or merger) form of some embodiments. A rule may be defined so that a base station informs a terminal of information on whether the embodiments are applied (or information on rules of the embodiments) through a predefined signal (e.g., a physical layer signal or a higher layer signal). Here, a higher layer may include, for example, at least one of functional layers such as MAC, RLC, PDCP, RRC, and SDAP. In addition, embodiments of the present disclosure may be also applied to a technology for estimating an accurate position of a terminal.

FIG. 9 is a flowchart for describing uplink transmission of a terminal according to an embodiment of the present disclosure.

In S910, a terminal may transmit information related to a time reference adjustment value to a base station based on a threshold for a time reference adjustment value.

The threshold may be a threshold for an offset of information related to a time reference adjustment value.

For example, when an offset between information related to a current time reference adjustment value of a terminal and information related to a previous time reference adjustment value is equal to or greater than/exceeds the threshold, reporting of information related to a time reference adjustment value may be triggered.

Alternatively, when an offset between information related to a current time reference adjustment value of a terminal and information related to a previous time reference adjustment value is below/equal to or less than the threshold, reporting of information related to a time reference adjustment may not be triggered.

Here, reporting of information related to a time reference adjustment value to a base station may be performed in a random access process or in a RRC connection mode.

In addition, information related to a previous time reference adjustment value may be information related to a recently (or last) successfully reported time reference adjustment value.

In addition, whether reporting of information related to a time reference adjustment value is allowed may be configured by the base station to the terminal, and if allowed, a terminal may perform reporting of information related to a time reference adjustment value based on the threshold.

In addition, a terminal may update/report information related to a time reference adjustment value during a time duration in which satellite orbit information is valid.

Information related to a time reference adjustment value may include at least one of an absolute value of information related to the time reference adjustment value or a difference value between information related to a previous time reference adjustment value and information on a current time reference adjustment value.

Based on information related to a time reference adjustment value being updated, information related to the time reference adjustment value may be reported to the base station.

In S920, a terminal may perform uplink transmission based on information related to a time reference adjustment value.

For example, when an offset between information related to a current time reference adjustment value of a terminal and information related to a previous time reference adjustment value is equal to or greater than/exceeds the threshold, reporting of information related to a time reference adjustment value may be triggered and uplink transmission may be performed based on reported information related to a time reference adjustment value (i.e., a current time reference adjustment value).

Alternatively, when an offset between information related to a current time reference adjustment value of a terminal and information related to a previous time reference adjustment value is below/equal to or less than the threshold, reporting of information related to a time reference adjustment value may not be triggered and uplink transmission may be performed based on information related to a previous time reference adjustment value.

FIG. 10 is a flowchart for describing uplink reception of a base station according to an embodiment of the present disclosure.

In S1010, a base station may receive information related to a time reference adjustment value transmitted from a terminal based on a threshold for a time reference adjustment value.

Examples for transmission of a time reference adjustment value from a terminal are the same as an example for S910 in FIG. 9, so an overlapping description is omitted.

In S1020, a base station may receive uplink transmission from a terminal based on information related to a time reference adjustment value.

Examples for uplink reception from a terminal are the same as an example for S920 in FIG. 9, so an overlapping description is omitted.

In an example of FIG. 9 and FIG. 10, a time reference adjustment value may include a TA value. For example, a TA value may include at least one of a common TA or a UE-specific TA. In this case, the threshold may be configured for a UE-specific TA. In addition, an example of FIG. 9 and FIG. 10 may be applied to a terminal operation in a wireless communication system including a NTN system.

In an operation of a terminal or a base station in FIG. 9 and FIG. 10, Embodiment 1 and a combination of at least one of examples described in its detailed embodiments may be applied, and an overlapping description is omitted.

FIG. 11 is a diagram for describing a signaling process according to an embodiment of the present disclosure.

FIG. 11 represents an example of signaling between a network side (or a base station) and a terminal (UE) in a situation when at least one physical channel/signal to which the above-described examples of the present disclosure (e.g., Embodiment 1, 2, and a combination of at least one of examples described in detailed embodiments thereof) may be applied is NTN-transmitted.

Here, UE/a network side is illustrative and may be applied by being replaced with a variety of devices as described by referring to FIG. 12. FIG. 11 is for convenience of a description, and it does not limit a scope of the present disclosure. In addition, some step(s) shown in FIG. 11 may be omitted depending on a situation and/or a configuration, etc. In addition, in an operation of a network side/UE in FIG. 11, the above-described uplink transmission or reception operation, etc. may be referred to or used.

In the following description, a network side may be one base station including a plurality of TRPs or may be one cell including a plurality of TRPs. Alternatively, a network side may include a plurality of remote radio heads (RRH)/remote radio units (RRU). In an example, an ideal/non-ideal backhaul may be configured between TRP 1 and TRP 2 configuring a network side. In addition, although the following description is described based on multiple TRPs, it may be extended and applied equally to transmission through multiple panels/cells, and it may be also extended and applied to transmission through multiple RRHs/RRUs.

In addition, in the following description, it is described based on a “TRP”, but as described above, “TRP” may be applied by being replaced with an expression such as a panel, an antenna array, a cell (e.g., a macro cell/a small cell/a picocell, etc.), a transmission point (TP), a base station (a base station, gNB, etc.), etc. As described above, a TRP may be distinguished according to information (e.g., a CORESET index, a ID) on a CORESET group (or a CORESET pool). In an example, when one terminal is configured to perform transmission or reception with multiple TRPs (or cells), it may mean that multiple CORESET groups (or CORESET pools) are configured for one terminal. Such a configuration for a CORESET group (or a CORESET pool) may be performed through higher layer signaling (e.g., RRC signaling, etc.).

In addition, a base station may generally mean an object which performs transmission or reception of data with a terminal. For example, the base station may be a concept including at least one transmission point (TP), at least one transmission and reception point (TRP), etc. In addition, a TP and/or a TRP may include a panel of a base station, a transmission and reception unit, etc.

A terminal may receive configuration information from a base station S105. For example, the configuration information may include NTN-related configuration information/configuration information for uplink transmission or reception (e.g., PUCCH-config/PUSCH-config)/a HARQ process-related configuration (e.g., whether HARQ feedback is enabled or disabled, the number of HARQ processes, etc.)/a CSI reporting-related configuration (e.g., a CSI report configuration (config)/CSI report quantity/a CSI-RS resource configuration (resource config), etc.), etc. described in the above-described embodiment (e.g., Embodiment 1, 2, and a combination of at least one of examples described in detailed embodiments thereof). For example, configuration information may include information related to a configuration/an indication related to update/reporting/application of a time/frequency reference adjustment value of a terminal. For example, the configuration information may be transmitted through higher layer (e.g., RRC or a MAC CE) signaling.

For example, the above-described operation in S105 that a terminal (100 or 200 in FIG. 12) receives the configuration information from a base station (200 or 100 in FIG. 12) may be implemented by a device of FIG. 12 to be described below. For example, in reference to FIG. 12, at least one processor 102 may control at least one transceiver 106 and/or at least one memory 104, etc. to receive the configuration information, and at least one transceiver 106 may receive the configuration information from a network side.

A terminal may receive control information from a base station S110. For example, control information may include information related to a configuration/an indication related to update/reporting/application of a time/frequency reference adjustment value of a terminal. For example, control information may include a command (e.g., a TAC and/or a FAC) for a time/frequency reference adjustment value of a terminal. For example, a terminal may receive DCI including a PDCCH order from a base station.

For example, the above-described operation in S110 that UE (100 or 200 in FIG. 12) transmits the DCI to a base station (200 or 100 in FIG. 12) may be implemented by a device of FIG. 12 to be described below. For example, in reference to FIG. 12, at least one processor 102 may control at least one transceiver 106 and/or at least one memory 104, etc. to transmit the control information, and at least one transceiver 106 may transmit the control information to a base station.

A terminal may transmit uplink data/channel to a base station S115. For example, a terminal may transmit uplink data/channel to a base station based on the above-described embodiment (e.g., Embodiment 1, 2, and a combination of at least one of examples described in detailed embodiments thereof), etc. For example, a terminal may report information related to a time/frequency reference adjustment value to a base station through an uplink signal/channel. For example, a terminal may transmit uplink data/channel/signal to a base station based on a time/frequency reference adjustment value.

For example, the above-described operation in S115 that a terminal (100 or 200 in FIG. 12) transmits uplink data/channel may be implemented by a device of FIG. 12 below. For example, in reference to FIG. 12, at least one processor 102 may control at least one memory 104, etc. to transmit the uplink data/channel.

As mentioned above, the above-described signaling of a base station/a terminal and embodiment (e.g., Embodiment 1, 2, and a combination of at least one of examples described in detailed embodiments thereof) may be implemented by a device which will be described by referring to FIG. 12. For example, a base station may correspond to a first device 100 and a terminal may correspond to a second device 200, and the opposite case may be also considered in some cases.

For example, the above-described signaling and operation of a base station/a terminal (e.g., Embodiment 1, 2, and a combination of at least one of examples described in detailed embodiments thereof) may be processed by at least one processor (e.g., 102, 202) in FIG. 12, and the above-described signaling and operation of a base station/a terminal (e.g., Embodiment 1, 2, and a combination of at least one of examples described in detailed embodiments thereof) may be stored in a memory (e.g., at least one memory (e.g., 104, 204) in FIG. 12) in a command/program (e.g., an instruction, an executable code) form for driving at least one processor (e.g., 102, 202) in FIG. 12.

General Device to which the Present Disclosure May be Applied

FIG. 12 illustrates a block diagram of a wireless communication device according to an embodiment of the present disclosure.

In reference to FIG. 12, a first wireless device 100 and a second wireless device 200 may transmit and receive a wireless signal through a variety of radio access technologies (e.g., LTE, NR).

A first wireless device 100 may include one or more processors 102 and one or more memories 104 and may additionally include one or more transceivers 106 and/or one or more antennas 108. A processor 102 may control a memory 104 and/or a transceiver 106 and may be configured to implement description, functions, procedures, proposals, methods and/or operation flow charts disclosed in the present disclosure. For example, a processor 102 may transmit a wireless signal including first information/signal through a transceiver 106 after generating first information/signal by processing information in a memory 104. In addition, a processor 102 may receive a wireless signal including second information/signal through a transceiver 106 and then store information obtained by signal processing of second information/signal in a memory 104. A memory 104 may be connected to a processor 102 and may store a variety of information related to an operation of a processor 102. For example, a memory 104 may store a software code including commands for performing all or part of processes controlled by a processor 102 or for performing description, functions, procedures, proposals, methods and/or operation flow charts disclosed in the present disclosure. Here, a processor 102 and a memory 104 may be part of a communication modem/circuit/chip designed to implement a wireless communication technology (e.g., LTE, NR). A transceiver 106 may be connected to a processor 102 and may transmit and/or receive a wireless signal through one or more antennas 108. A transceiver 106 may include a transmitter and/or a receiver. A transceiver 106 may be used together with a RF (Radio Frequency) unit. In the present disclosure, a wireless device may mean a communication modem/circuit/chip.

A second wireless device 200 may include one or more processors 202 and one or more memories 204 and may additionally include one or more transceivers 206 and/or one or more antennas 208. A processor 202 may control a memory 204 and/or a transceiver 206 and may be configured to implement description, functions, procedures, proposals, methods and/or operation flows charts disclosed in the present disclosure. For example, a processor 202 may generate third information/signal by processing information in a memory 204, and then transmit a wireless signal including third information/signal through a transceiver 206. In addition, a processor 202 may receive a wireless signal including fourth information/signal through a transceiver 206, and then store information obtained by signal processing of fourth information/signal in a memory 204. A memory 204 may be connected to a processor 202 and may store a variety of information related to an operation of a processor 202. For example, a memory 204 may store a software code including commands for performing all or part of processes controlled by a processor 202 or for performing description, functions, procedures, proposals, methods and/or operation flow charts disclosed in the present disclosure. Here, a processor 202 and a memory 204 may be part of a communication modem/circuit/chip designed to implement a wireless communication technology (e.g., LTE, NR). A transceiver 206 may be connected to a processor 202 and may transmit and/or receive a wireless signal through one or more antennas 208. A transceiver 206 may include a transmitter and/or a receiver. A transceiver 206 may be used together with a RF unit. In the present disclosure, a wireless device may mean a communication modem/circuit/chip.

Hereinafter, a hardware element of a wireless device 100, 200 will be described in more detail. It is not limited thereto, but one or more protocol layers may be implemented by one or more processors 102, 202. For example, one or more processors 102, 202 may implement one or more layers (e.g., a functional layer such as PHY, MAC, RLC, PDCP, RRC, SDAP). One or more processors 102, 202 may generate one or more PDUs (Protocol Data Unit) and/or one or more SDUs (Service Data Unit) according to description, functions, procedures, proposals, methods and/or operation flow charts included in the present disclosure. One or more processors 102, 202 may generate a message, control information, data or information according to description, functions, procedures, proposals, methods and/or operation flow charts disclosed in the present disclosure. One or more processors 102, 202 may generate a signal (e.g., a baseband signal) including a PDU, a SDU, a message, control information, data or information according to functions, procedures, proposals and/or methods disclosed in the present disclosure to provide it to one or more transceivers 106, 206. One or more processors 102, 202 may receive a signal (e.g., a baseband signal) from one or more transceivers 106, 206 and obtain a PDU, a SDU, a message, control information, data or information according to description, functions, procedures, proposals, methods and/or operation flow charts disclosed in the present disclosure.

One or more processors 102, 202 may be referred to as a controller, a micro controller, a micro processor or a micro computer. One or more processors 102, 202 may be implemented by a hardware, a firmware, a software, or their combination. In an example, one or more ASICs (Application Specific Integrated Circuit), one or more DSPs (Digital Signal Processor), one or more DSPDs (Digital Signal Processing Device), one or more PLDs (Programmable Logic Device) or one or more FPGAs (Field Programmable Gate Arrays) may be included in one or more processors 102, 202. Description, functions, procedures, proposals, methods and/or operation flow charts disclosed in the present disclosure may be implemented by using a firmware or a software and a firmware or a software may be implemented to include a module, a procedure, a function, etc. A firmware or a software configured to perform description, functions, procedures, proposals, methods and/or operation flow charts disclosed in the present disclosure may be included in one or more processors 102, 202 or may be stored in one or more memories 104, 204 and driven by one or more processors 102, 202. Description, functions, procedures, proposals, methods and/or operation flow charts disclosed in the present disclosure may be implemented by using a firmware or a software in a form of a code, a command and/or a set of commands.

One or more memories 104, 204 may be connected to one or more processors 102, 202 and may store data, a signal, a message, information, a program, a code, an instruction and/or a command in various forms. One or more memories 104, 204 may be configured with ROM, RAM, EPROM, a flash memory, a hard drive, a register, a cash memory, a computer readable storage medium and/or their combination. One or more memories 104, 204 may be positioned inside and/or outside one or more processors 102, 202. In addition, one or more memories 104, 204 may be connected to one or more processors 102, 202 through a variety of technologies such as a wire or wireless connection.

One or more transceivers 106, 206 may transmit user data, control information, a wireless signal/channel, etc. mentioned in methods and/or operation flow charts, etc. of the present disclosure to one or more other devices. One or more transceivers 106, 206 may receiver user data, control information, a wireless signal/channel, etc. mentioned in description, functions, procedures, proposals, methods and/or operation flow charts, etc. disclosed in the present disclosure from one or more other devices. For example, one or more transceivers 106, 206 may be connected to one or more processors 102, 202 and may transmit and receive a wireless signal. For example, one or more processors 102, 202 may control one or more transceivers 106, 206 to transmit user data, control information or a wireless signal to one or more other devices. In addition, one or more processors 102, 202 may control one or more transceivers 106, 206 to receive user data, control information or a wireless signal from one or more other devices. In addition, one or more transceivers 106, 206 may be connected to one or more antennas 108, 208 and one or more transceivers 106, 206 may be configured to transmit and receive user data, control information, a wireless signal/channel, etc. mentioned in description, functions, procedures, proposals, methods and/or operation flow charts, etc. disclosed in the present disclosure through one or more antennas 108, 208. In the present disclosure, one or more antennas may be a plurality of physical antennas or a plurality of logical antennas (e.g., an antenna port). One or more transceivers 106, 206 may convert a received wireless signal/channel, etc. into a baseband signal from a RF band signal to process received user data, control information, wireless signal/channel, etc. by using one or more processors 102, 202. One or more transceivers 106, 206 may convert user data, control information, a wireless signal/channel, etc. which are processed by using one or more processors 102, 202 from a baseband signal to a RF band signal. Therefor, one or more transceivers 106, 206 may include an (analogue) oscillator and/or a filter.

Embodiments described above are that elements and features of the present disclosure are combined in a predetermined form. Each element or feature should be considered to be optional unless otherwise explicitly mentioned. Each element or feature may be implemented in a form that it is not combined with other element or feature. In addition, an embodiment of the present disclosure may include combining a part of elements and/or features. An order of operations described in embodiments of the present disclosure may be changed. Some elements or features of one embodiment may be included in other embodiment or may be substituted with a corresponding element or a feature of other embodiment. It is clear that an embodiment may include combining claims without an explicit dependency relationship in claims or may be included as a new claim by amendment after application.

It is clear to a person skilled in the pertinent art that the present disclosure may be implemented in other specific form in a scope not going beyond an essential feature of the present disclosure. Accordingly, the above-described detailed description should not be restrictively construed in every aspect and should be considered to be illustrative. A scope of the present disclosure should be determined by reasonable construction of an attached claim and all changes within an equivalent scope of the present disclosure are included in a scope of the present disclosure.

A scope of the present disclosure includes software or machine-executable commands (e.g., an operating system, an application, a firmware, a program, etc.) which execute an operation according to a method of various embodiments in a device or a computer and a non-transitory computer-readable medium that such a software or a command, etc. are stored and are executable in a device or a computer. A command which may be used to program a processing system performing a feature described in the present disclosure may be stored in a storage medium or a computer-readable storage medium and a feature described in the present disclosure may be implemented by using a computer program product including such a storage medium. A storage medium may include a high-speed random-access memory such as DRAM, SRAM, DDR RAM or other random-access solid state memory device, but it is not limited thereto, and it may include a nonvolatile memory such as one or more magnetic disk storage devices, optical disk storage devices, flash memory devices or other nonvolatile solid state storage devices. A memory optionally includes one or more storage devices positioned remotely from processor(s). A memory or alternatively, nonvolatile memory device(s) in a memory include a non-transitory computer-readable storage medium. A feature described in the present disclosure may be stored in any one of machine-readable mediums to control a hardware of a processing system and may be integrated into a software and/or a firmware which allows a processing system to interact with other mechanism utilizing a result from an embodiment of the present disclosure. Such a software or a firmware may include an application code, a device driver, an operating system and an execution environment/container, but it is not limited thereto.

Here, a wireless communication technology implemented in a wireless device 100, 200 of the present disclosure may include Narrowband Internet of Things for a low-power communication as well as LTE, NR and 6G. Here, for example, an NB-IoT technology may be an example of a LPWAN (Low Power Wide Area Network) technology, may be implemented in a standard of LTE Cat NB1 and/or LTE Cat NB2, etc. and is not limited to the above-described name. Additionally or alternatively, a wireless communication technology implemented in a wireless device 100, 200 of the present disclosure may perform a communication based on a LTE-M technology. Here, in an example, a LTE-M technology may be an example of a LPWAN technology and may be referred to a variety of names such as an eMTC (enhanced Machine Type Communication), etc. For example, an LTE-M technology may be implemented in at least any one of various standards including 1) LTE CAT 0, 2) LTE Cat M1, 3) LTE Cat M2, 4) LTE non-BL (non-Bandwidth Limited), 5) LTE-MTC, 6) LTE Machine Type Communication, and/or 7) LTE M and so on and it is not limited to the above-described name. Additionally or alternatively, a wireless communication technology implemented in a wireless device 100, 200 of the present disclosure may include at least any one of a ZigBee, a Bluetooth and a low power wide area network (LPWAN) considering a low-power communication and it is not limited to the above-described name. In an example, a ZigBee technology may generate PAN (personal area networks) related to a small/low-power digital communication based on a variety of standards such as IEEE 802.15.4, etc. and may be referred to as a variety of names.

### INDUSTRIAL APPLICABILITY

A method proposed by the present disclosure is mainly described based on an example applied to 3GPP LTE/LTE-A, 5G system, but may be applied to various wireless communication systems other than the 3GPP LTE/LTE-A, 5G system.

1. A method of performing uplink transmission by a terminal in a wireless communication system, the method comprising:
transmitting to a base station information related to a time reference adjustment value based on a predetermined threshold for the time reference adjustment value; and
performing uplink transmission based on information related to the time reference adjustment value,
wherein based on an offset between information related to a current time reference adjustment value of the terminal and information related to a previous time reference adjustment value being equal to or greater than the predetermined threshold, reporting of information related to the time reference adjustment value to the base station is triggered.

2. The method according to claim 1, wherein:
based on the offset between information related to the current time reference adjustment value of the terminal and information related to the previous time reference adjustment value being less than the predetermined threshold, reporting of information related to the time reference adjustment value to the base station is not triggered,
the uplink transmission is performed based on information related to the previous time reference adjustment value.

3. The method according to claim 1, wherein:
information related to the previous time reference adjustment value is information related to the time reference adjustment value which is recently successfully reported from the terminal to the base station.

4. The method according to claim 1, wherein:
reporting of information related to the time reference adjustment value is transmitted to the base station in a random access process.

5. The method according to claim 1, wherein:
reporting of information related to the time reference adjustment value is transmitted to the base station in a radio resource control (RRC) connection mode.

6. The method according to claim 1, wherein:
whether reporting of information related to the time reference adjustment value is allowed is configured by the base station to the terminal.

7. The method according to claim 1, wherein:
the predetermined threshold is the threshold for the offset of information related to the time reference adjustment value.

8. The method according to claim 1, wherein:
the time reference adjustment value includes a timing advance (TA) value.

9. The method according to claim 1, wherein:
the time reference adjustment value includes at least one of a common TA or a UE-specific TA.

10. The method according to claim 1, wherein:
the predetermined threshold is configured for a UE-specific TA.

11. The method according to claim 1, wherein:
during a time duration that satellite orbit information is valid, information related to the time reference adjustment value is transmitted to the base station.

12. The method according to claim 1, wherein:
information related to the time reference adjustment value includes at least one of an absolute value of information related to the time reference adjustment value or a difference value between information related to the previous time reference adjustment value and information for the current time reference adjustment value.

13. The method according to claim 1, wherein:
based on information related to the time reference adjustment value being updated, information related to the time reference adjustment value is reported to the base station.

14. The method according to claim 1, wherein:
the wireless communication system is a non-terrestrial network (NTN) system.

15. A terminal for performing uplink transmission in a wireless communication system, the terminal comprising:
at least one transceiver; and
at least one processor connected to the at least one transceiver,
wherein the at least one processor is configured to:
transmit to a base station through the transceiver information related to a time reference adjustment value based on a predetermined threshold for the time reference adjustment value; and
perform uplink transmission through the transceiver based on information related to the time reference adjustment value.

16. A method of receiving uplink transmission in a wireless communication system, the method comprising:
receiving information related to a time reference adjustment value transmitted from a terminal based on a predetermined threshold for the time reference adjustment value; and
receiving uplink transmission from the terminal based on information related to the time reference adjustment value.

17. A base station for receiving uplink transmission in a wireless communication system, the base station comprising:
at least one transceiver; and
at least one processor connected to the at least one transceiver,
wherein the at least one processor is configured to:
receive from a terminal through the transceiver information related to a time reference adjustment value based on a predetermined threshold for the time reference adjustment value; and
receive through the transceiver uplink transmission from the terminal based on information related to the time reference adjustment value.

18. A processing unit configured to control a terminal to perform uplink transmission in a wireless communication system, the processing unit comprising:
at least one processor; and
at least one computer memory which is operably connected to the at least one processor and stores instructions performing operations based on being executed by the at least one processor,
wherein the operations include:
transmitting to a base station information related to a time reference adjustment value based on a predetermined threshold for the time reference adjustment value; and
performing uplink transmission based on information related to the time reference adjustment value.

19. At least one non-transitory computer readable medium storing at least one instruction, wherein:
the at least one instruction controls a device which performs uplink transmission in a wireless communication system by being executed by at least one processor to:
transmit to a base station information related to a time reference adjustment value based on a predetermined threshold for the time reference adjustment value; and
perform uplink transmission based on information related to the time reference adjustment value.
